(19) United States
(12) Patent Application Publication
(10) Pub. No.: US 2023/0354308 A1
(43) Pub. Date: Nov. 2, 2023

(54) DYNAMIC PATH SWITCH VIA ASSISTING NODE

(71) Applicant: QUALCOMM Incorporated, San Diego, CA (US)

(72) Inventors: Navid ABEDINI, Basking Ridge, NJ (US); Kapil GULATI, Belle Mead, NJ (US); Sourjya DUTTA, San Diego, CA (US); Naeem AKL, Somerville, NJ (US); Tao LUO, San Diego, CA (US)

(21) Appl. No.: 17/661,690

(22) Filed: May 2, 2022

(51) Int. Cl. H04W 72/12; H04L 1/18; H04W 40/12

(52) U.S. Cl. CPC H04W 72/1268; H04L 1/1864; H04W 40/12

(57) ABSTRACT

Various aspects of the present disclosure generally relate to wireless communication. In some aspects, a user equipment (UE) may transmit, to a network entity, an indication of a required minimum value for a time offset associated with a communication with the network entity, wherein the required minimum value for the time offset is associated with communicating with the network entity via an assisting node. The UE may receive, from the network entity, an indication of an offset value for the time offset based at least in part on the required minimum value for the time offset. The UE may communicate with the network entity via the assisting node in accordance with the offset value. Numerous other aspects are described.

### FIELD OF THE DISCLOSURE

Aspects of the present disclosure generally relate to wireless communication and to techniques and apparatuses for dynamic path switching via an assisting node.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of communicating using an assisting node, in accordance with the present disclosure.

FIG. 5 is a diagram illustrating an example of physical downlink control channel (PDCCH) scheduling of a physical downlink shared channel (PDSCH) communication to be transmitted to a UE via an assisting node, in accordance with the present disclosure.

FIGS. 6-7 are diagrams illustrating examples associated with dynamic path switching via an assisting node, in accordance with the present disclosure.

FIGS. 8-11 are diagrams illustrating example processes associated with dynamic path switching via an assisting node, in accordance with the present disclosure.

FIGS. 12-13 are diagrams of example apparatuses for wireless communication, in accordance with the present disclosure.

### SUMMARY

Some aspects described herein relate to a user equipment (UE) for wireless communication. The UE may include a memory and one or more processors coupled to the memory. The one or more processors may be configured to transmit, to a network entity, an indication of a required minimum value for a time offset associated with a communication with the network entity, wherein the required minimum value for the time offset is associated with communicating with the network entity via an assisting node. The one or more processors may be configured to receive, from the network entity, an indication of an offset value for the time offset based at least in part on the required minimum value for the time offset. The one or more processors may be configured to communicate with the network entity via the assisting node in accordance with the offset value.

Some aspects described herein relate to a UE for wireless communication. The UE may include a memory and one or more processors coupled to the memory. The one or more processors may be configured to receive, from a network entity, a configuration of a plurality of sets of offset values for a bandwidth part, for a time offset associated with a communication with the network entity. The one or more processors may be configured to receive, from the network entity, an indication of an offset value, in a set of offset values of the plurality of sets of offset values, for the time offset. The one or more processors may be configured to communicate with the network entity in accordance with the offset value.

Some aspects described herein relate to a network entity for wireless communication. The network entity may include a memory and one or more processors coupled to the memory. The one or more processors may be configured to receive an indication of a required minimum value for a time offset associated with a communication with a UE, wherein the required minimum value for the time offset is associated with communicating with the UE via an assisting node. The one or more processors may be configured to transmit, to the UE, an indication of an offset value for the time offset based at least in part on the required minimum value for the time offset. The one or more processors may be configured to communicate with the UE in accordance with the offset value.

Some aspects described herein relate to a network entity for wireless communication. The network entity may include a memory and one or more processors coupled to the memory. The one or more processors may be configured to transmit, to a UE, a configuration of a plurality of sets of offset values for a bandwidth part, for a time offset associated with a communication with the UE. The one or more processors may be configured to transmit, to the UE, an indication of an offset value, in a set of offset values of the plurality of sets of offset values, for the time offset. The one or more processors may be configured to communicate with the UE in accordance with the offset value.

Some aspects described herein relate to a method of wireless communication performed by a UE. The method may include transmitting, to a network entity, an indication of a required minimum value for a time offset associated with a communication with the network entity, wherein the required minimum value for the time offset is associated with communicating with the network entity via an assisting node. The method may include receiving, from the network entity, an indication of an offset value for the time offset based at least in part on the required minimum value for the time offset. The method may include communicating with the network entity via the assisting node in accordance with the offset value.

Some aspects described herein relate to a method of wireless communication performed by a UE. The method may include receiving, from a network entity, a configuration of a plurality of sets of offset values for a bandwidth part, for a time offset associated with a communication with the network entity. The method may include receiving, from the network entity, an indication of an offset value, in a set of offset values of the plurality of sets of offset values, for the time offset. The method may include communicating with the network entity in accordance with the offset value.

Some aspects described herein relate to a method of wireless communication performed by a network entity. The method may include receiving an indication of a required minimum value for a time offset associated with a communication with a UE, wherein the required minimum value for the time offset is associated with communicating with the UE via an assisting node. The method may include transmitting, to the UE, an indication of an offset value for the time offset based at least in part on the required minimum value for the time offset. The method may include communicating with the UE in accordance with the offset value.

Some aspects described herein relate to a method of wireless communication performed by a network entity. The method may include transmitting, to a UE, a configuration of a plurality of sets of offset values for a bandwidth part, for a time offset associated with a communication with the UE. The method may include transmitting, to the UE, an indication of an offset value, in a set of offset values of the plurality of sets of offset values, for the time offset. The method may include communicating with the UE in accordance with the offset value.

Some aspects described herein relate to a non-transitory computer-readable medium that stores a set of instructions for wireless communication by a UE. The set of instructions, when executed by one or more processors of the UE, may cause the UE to transmit, to a network entity, an indication of a required minimum value for a time offset associated with a communication with the network entity, wherein the required minimum value for the time offset is associated with communicating with the network entity via an assisting node. The set of instructions, when executed by one or more processors of the UE, may cause the UE to receive, from the network entity, an indication of an offset value for the time offset based at least in part on the required minimum value for the time offset. The set of instructions, when executed by one or more processors of the UE, may cause the UE to communicate with the network entity via the assisting node in accordance with the offset value.

Some aspects described herein relate to a non-transitory computer-readable medium that stores a set of instructions for wireless communication by a UE. The set of instructions, when executed by one or more processors of the UE, may cause the UE to receive, from a network entity, a configuration of a plurality of sets of offset values for a bandwidth part, for a time offset associated with a communication with the network entity. The set of instructions, when executed by one or more processors of the UE, may cause the UE to receive, from the network entity, an indication of an offset value, in a set of offset values of the plurality of sets of offset values, for the time offset. The set of instructions, when executed by one or more processors of the UE, may cause the UE to communicate with the network entity in accordance with the offset value.

Some aspects described herein relate to a non-transitory computer-readable medium that stores a set of instructions for wireless communication by a network entity. The set of instructions, when executed by one or more processors of the network entity, may cause the network entity to receive an indication of a required minimum value for a time offset associated with a communication with a UE, wherein the required minimum value for the time offset is associated with communicating with the UE via an assisting node. The set of instructions, when executed by one or more processors of the network entity, may cause the network entity to transmit, to the UE, an indication of an offset value for the time offset based at least in part on the required minimum value for the time offset. The set of instructions, when executed by one or more processors of the network entity, may cause the network entity to communicate with the UE in accordance with the offset value.

Some aspects described herein relate to a non-transitory computer-readable medium that stores a set of instructions for wireless communication by a network entity. The set of instructions, when executed by one or more processors of the network entity, may cause the network entity to transmit, to a UE, a configuration of a plurality of sets of offset values for a bandwidth part, for a time offset associated with a communication with the UE. The set of instructions, when executed by one or more processors of the network entity, may cause the network entity to transmit, to the UE, an indication of an offset value, in a set of offset values of the plurality of sets of offset values, for the time offset. The set of instructions, when executed by one or more processors of the network entity, may cause the network entity to communicate with the UE in accordance with the offset value.

Some aspects described herein relate to an apparatus for wireless communication. The apparatus may include means for transmitting, to a network entity, an indication of a required minimum value for a time offset associated with a communication with the network entity, wherein the required minimum value for the time offset is associated with communicating with the network entity via an assisting node. The apparatus may include means for receiving, from the network entity, an indication of an offset value for the time offset based at least in part on the required minimum value for the time offset. The apparatus may include means for communicating with the network entity via the assisting node in accordance with the offset value.

Some aspects described herein relate to an apparatus for wireless communication. The apparatus may include means for receiving, from a network entity, a configuration of a plurality of sets of offset values for a bandwidth part, for a time offset associated with a communication with the network entity. The apparatus may include means for receiving, from the network entity, an indication of an offset value, in a set of offset values of the plurality of sets of offset values, for the time offset. The apparatus may include means for communicating with the network entity in accordance with the offset value.

Some aspects described herein relate to an apparatus for wireless communication. The apparatus may include means for receiving an indication of a required minimum value for a time offset associated with a communication with a UE, wherein the required minimum value for the time offset is associated with communicating with the UE via an assisting node. The apparatus may include means for transmitting, to the UE, an indication of an offset value for the time offset based at least in part on the required minimum value for the time offset. The apparatus may include means for communicating with the UE in accordance with the offset value.

Some aspects described herein relate to an apparatus for wireless communication. The apparatus may include means for transmitting, to a UE, a configuration of a plurality of sets of offset values for a bandwidth part, for a time offset associated with a communication with the UE. The apparatus may include means for transmitting, to the UE, an indication of an offset value, in a set of offset values of the plurality of sets of offset values, for the time offset. The apparatus may include means for communicating with the UE in accordance with the offset value.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

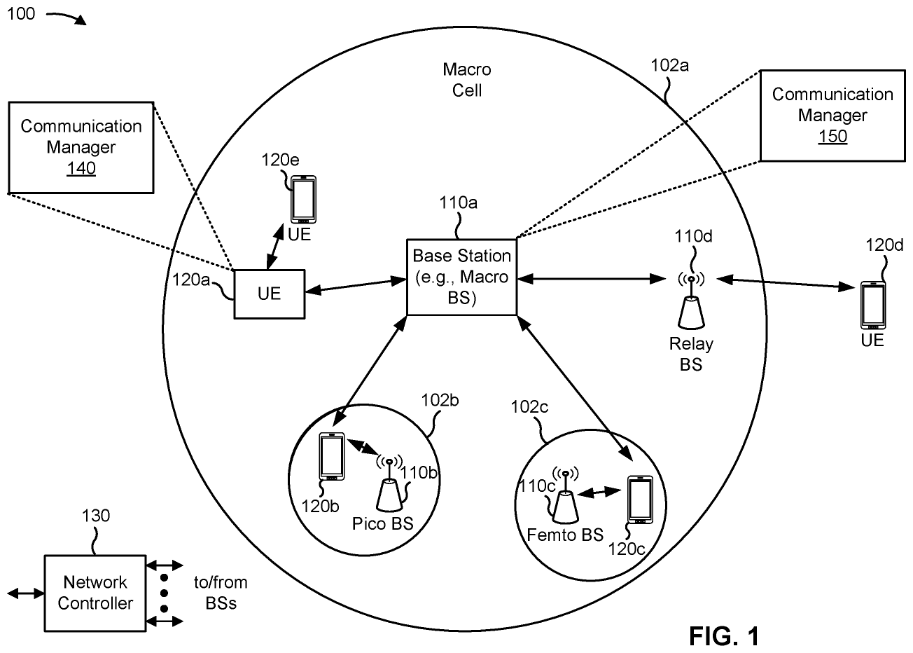

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network entity, an indication of a required minimum value for a time offset associated with a communication with the network entity, wherein the required minimum value for the time offset is associated with communicating with the network entity via an assisting node; receive, from the network entity, an indication of an offset value for the time offset based at least in part on the required minimum value for the time offset; and communicate with the network entity via the assisting node in accordance with the offset value. Additionally, or alternatively, the communication manager 140 may perform one or more other operations described herein.

In some aspects, as described in more detail elsewhere herein, the communication manager 140 may receive, from a network entity, a configuration of a plurality of sets of offset values for a bandwidth part, for a time offset associated with a communication with the network entity; receive, from the network entity, an indication of an offset value, in a set of offset values of the plurality of sets of offset values, for the time offset; and communicate with the network entity in accordance with the offset value. Additionally, or alternatively, the communication manager 140 may perform one or more other operations described herein.

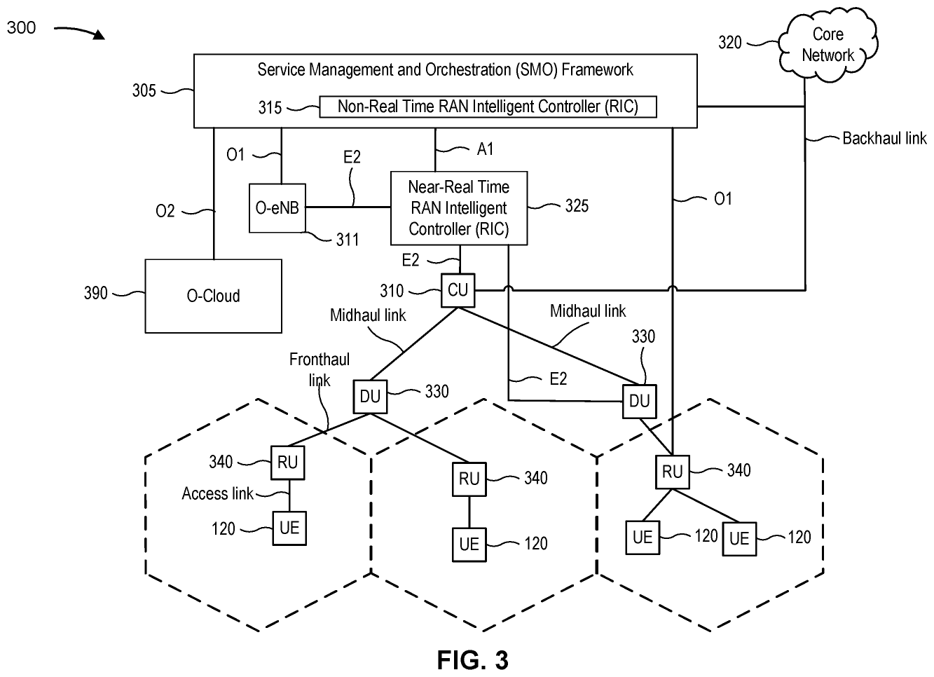

In some aspects, a network entity (e.g., base station 110 or one or more components described in connection with FIG. 3) may include a communication manager 150. As described in more detail elsewhere herein, the communication manager 150 may receive an indication of a required minimum value for a time offset associated with a communication with a UE, wherein the required minimum value for the time offset is associated with communicating with the UE via an assisting node; transmit, to the UE, an indication of an offset value for the time offset based at least in part on the required minimum value for the time offset; and communicate with the UE in accordance with the offset value. Additionally, or alternatively, the communication manager 150 may perform one or more other operations described herein.

In some aspects, as described in more detail elsewhere herein, the communication manager 150 may transmit, to a UE, a configuration of a plurality of sets of offset values for a bandwidth part, for a time offset associated with a communication with the network entity; transmit, to the UE, an indication of an offset value, in a set of offset values of the plurality of sets of offset values, for the time offset; and communicate with the UE in accordance with the offset value. Additionally, or alternatively, the communication manager 150 may perform one or more other operations described herein.

As indicated above, FIG. 1 is provided as an example. Other examples may differ from what is described with regard to FIG. 1.

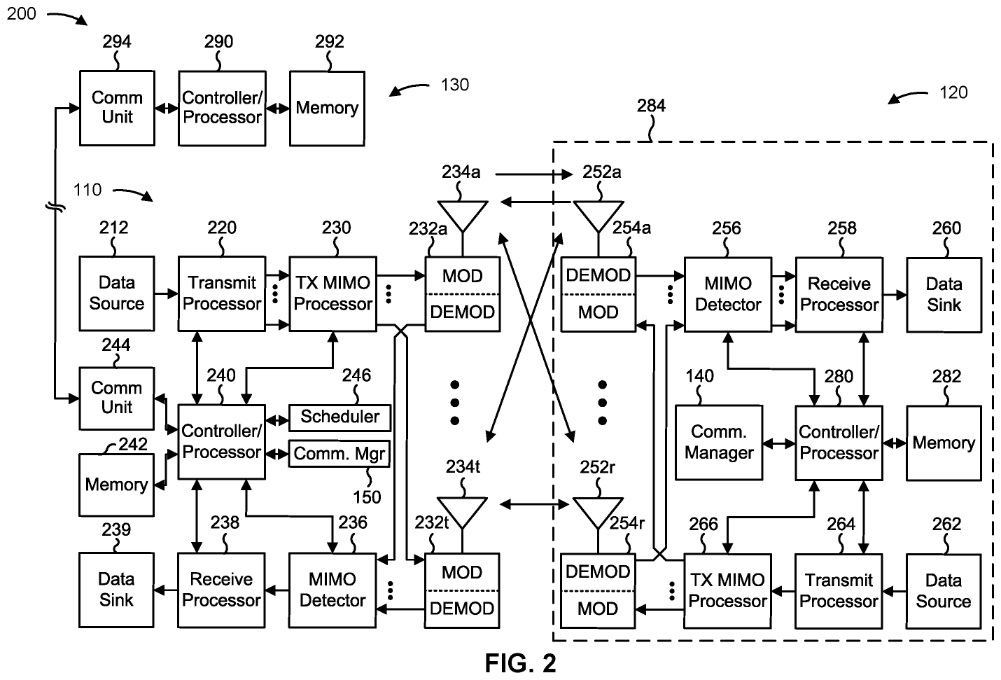

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

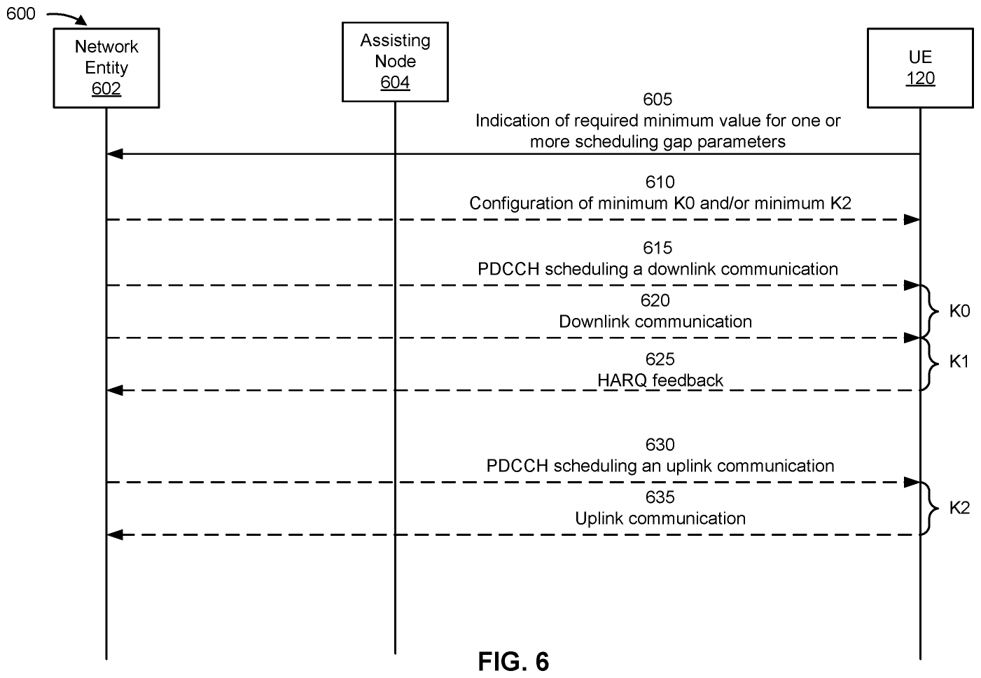

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

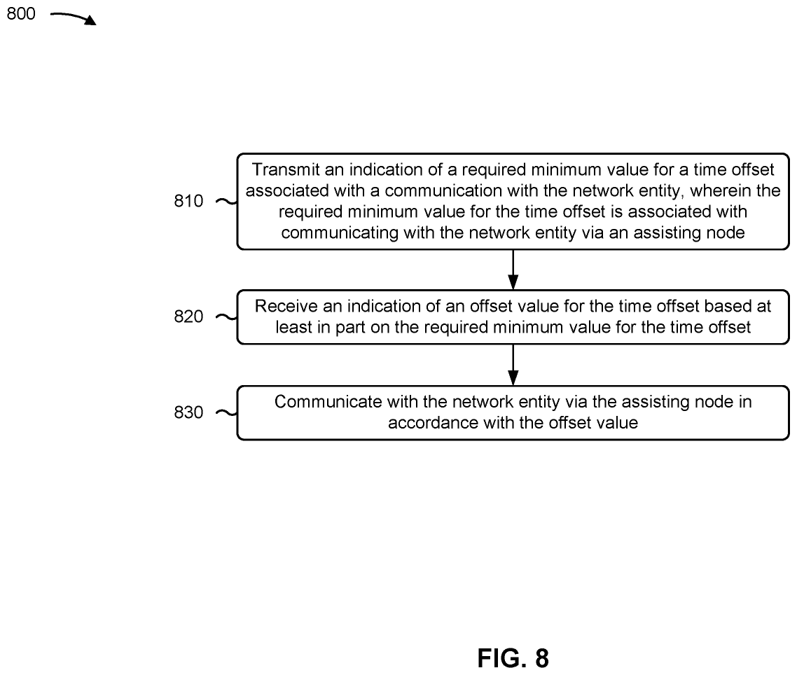

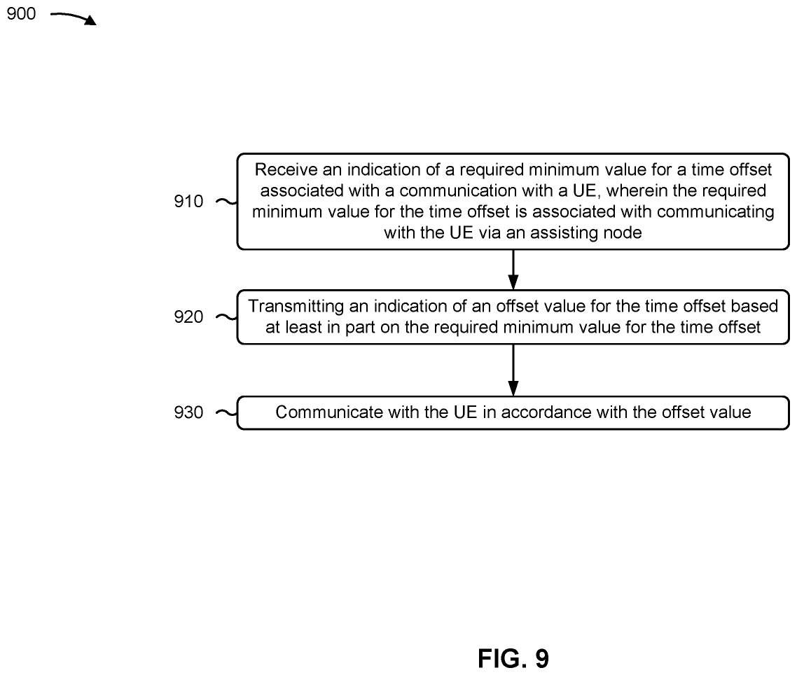

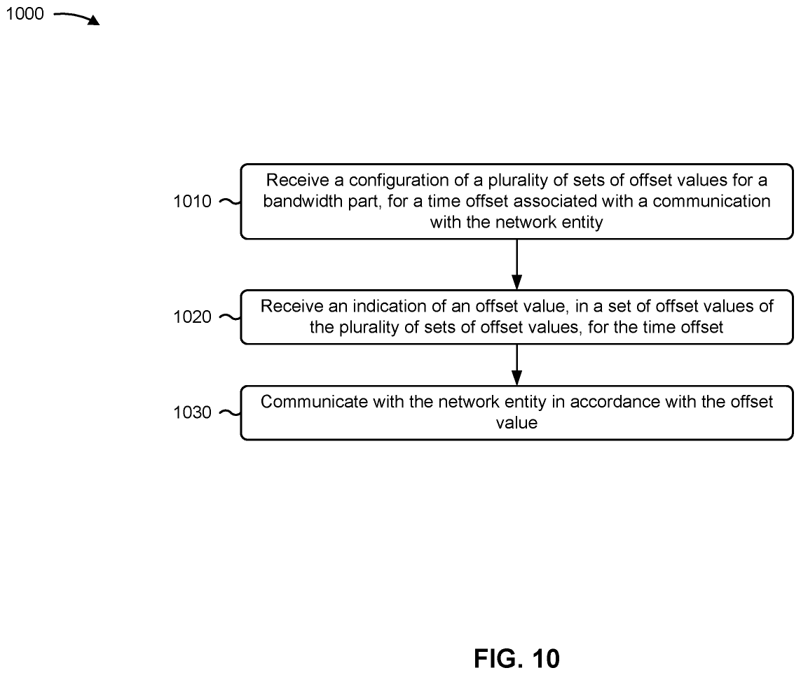

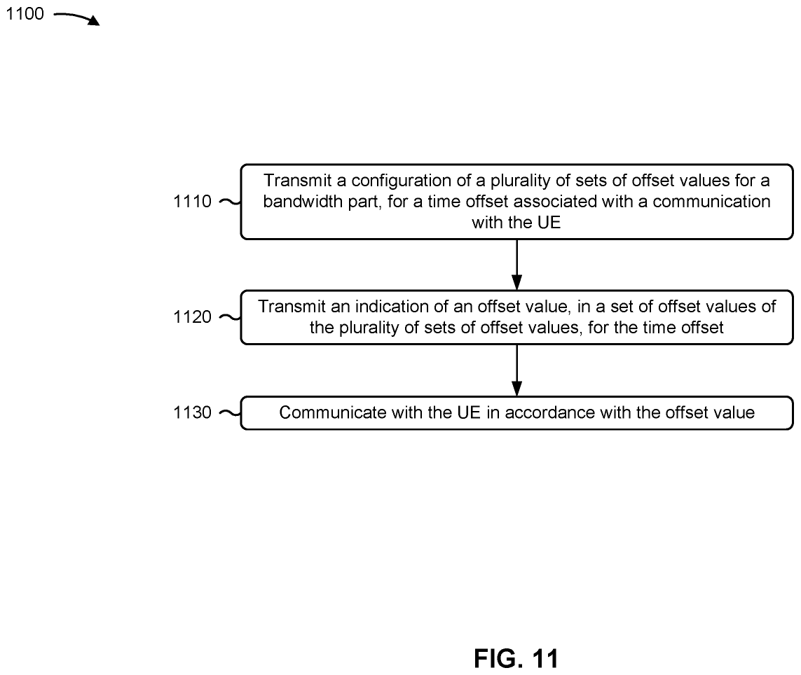

The controller/processor 240 of the base station 110, the controller/processor 280 of the UE 120, and/or any other component(s) of FIG. 2 may perform one or more techniques associated with dynamic path switching via an assisting node, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2.

In some aspects, the UE 120 includes means for transmitting, to a network entity, an indication of a required minimum value for a time offset associated with a communication with the network entity, wherein the required minimum value for the time offset is associated with communicating with the network entity via an assisting node; means for receiving, from the network entity, an indication of an offset value for the time offset based at least in part on the required minimum value for the time offset; and/or means for communicating with the network entity via the assisting node in accordance with the offset value. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving, from a network entity, a configuration of a plurality of sets of offset values for a bandwidth part, for a time offset associated with a communication with the network entity; means for receiving, from the network entity, an indication of an offset value, in a set of offset values of the plurality of sets of offset values, for the time offset; and/or means for communicating with the network entity in accordance with the offset value. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for receiving an indication of a required minimum value for a time offset associated with a communication with a UE, wherein the required minimum value for the time offset is associated with communicating with the UE via an assisting node; means for transmitting, to the UE, an indication of an offset value for the time offset based at least in part on the required minimum value for the time offset; and/or means for communicating with the UE in accordance with the offset value. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network entity includes means for transmitting, to a UE, a configuration of a plurality of sets of offset values for a bandwidth part, for a time offset associated with a communication with the UE; means for transmitting, to the UE, an indication of an offset value, in a set of offset values of the plurality of sets of offset values, for the time offset; and/or means for communicating with the UE in accordance with the offset value. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example disaggregated base station 300 architecture, in accordance with the present disclosure. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (MC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with respect to FIG. 3.

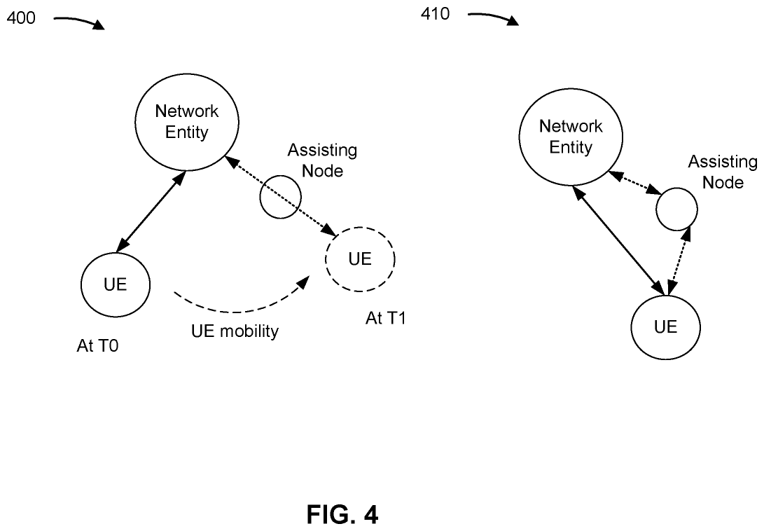

FIG. 4 is a diagram illustrating examples 400 and 410 of communicating using an assisting node, in accordance with the present disclosure. As shown in FIG. 4, examples 400 and 410 include communications between a UE (e.g., UE 120), a network entity (e.g., base station 110, CU 310, DU 330, RU 340, or a combination thereof), and an assisting node. The assisting node is a network device that relays, redirects, reflects, or forwards downlink and/or uplink communications between the network entity and the UE. In some examples, the assisting node may be a repeater (e.g., a smart repeater) that performs amplification signals transmitted by a transmitter device (e.g., the network entity or the UE) and forwards the signals to (e.g., in a beam direction toward) a receiving device (e.g., the UE or the network entity). In some examples, the assisting node may be a relay (e.g., a lower-layer relay), such as an RU or a TRP. In some examples, the assisting node may be a reconfigurable intelligent surface (RIS) (also referred to as an intelligent reflecting surface (IRS)) that dynamic control of signals reflected and/or redirected by the assisting node. The assisting node may extend the coverage of a cell associated with the network entity. For example, the assisting node may increase a coverage area of the network entity and/or extend coverage to UEs without line of sight to the network entity (e.g., due to an obstruction between the network entity and the UE). In some examples, a network (e.g., network 100) may include multiple assisting nodes that can serve the UE.

In some examples, there may be multiple paths for communications between the UE and the network entity. For example, one path (or beam) may be associated with a direct link between the network entity and the UE, and another path (or beam) may be associated with an indirect link, via the assisting node, between the network entity and the UE. As shown in example 400, in some cases, due to UE mobility (or channel variations), the UE may change the path/beam used for communicating with the network entity over time. For example, the UE may communicate with the network entity via a direct link at a first time (T0), and the UE may switch paths and communicate with the network entity via the assisting node at as second time (T1).

As shown in example 410, in some cases, there may be multiple paths between the UE and the network entity that are available at a given location and/or time. For example, the UE may be able to communicate with the network entity via a path/beam associated with a direct link between the UE and the network entity or via a path/beam associated with communications via the assisting node. In this case, the active/serving path (or beam) used for communications between the UE and the network entity may dynamically switch between the path associated with the direct link and the path associated with the assisting node. For example, the path (or beam) used for communications between the UE and the network entity may be dynamically switched based at least in part on a scheduler of the network entity or link quality measurements performed for the available paths. In some cases, there may be times at which the assisting node is not available to assist the UE with communications between the UE and the network entity (e.g., because the assisting node is busy serving other UEs). In some examples, switching between the path associated with the direct link and the path associated with the indirect link may follow a pattern (e.g., in a case in which the assisting node is only available in a subset of time and/or frequency resources).

In some examples, the network entity or the UE may control the assisting node. For example, the network entity or the UE may activate the assisting node, deactivate the assisting node, and/or dynamically adjust a configuration (e.g., beamforming, power, bandwidth, and/or transmission/reception timing reference parameters, among other examples) of the assisting node. In some examples, the network (e.g., the network entity) may control the assisting node. For example, one or more assisting nodes may be deployed in the network, and the network entity may control the assisting nodes and have full visibility to the assisting nodes (e.g., the network entity may be aware of which beams/paths are associated with communications via the assisting nodes). In some examples, the network (e.g., the network entity) may use/control one or more assisting nodes without visibility to the UE (e.g., the UE may not be aware of which beams/paths are associated with communications via the assisting nodes). In some examples, the UE may control the assisting node without visibility to the network entity (e.g., the network entity may not be aware of which beams/paths are associated with communications via the assisting node). In some examples, the assisting node may be visible to the network entity and the UE (e.g., both the network entity and the UE are aware of which beams/paths are associated with communications via the assisting node), and the assisting node may be controlled by either the network entity or the UE, or jointly by the network entity and the UE.

As indicated above, FIG. 4 is provided as an example. Other examples may differ from what is described with regard to FIG. 4.

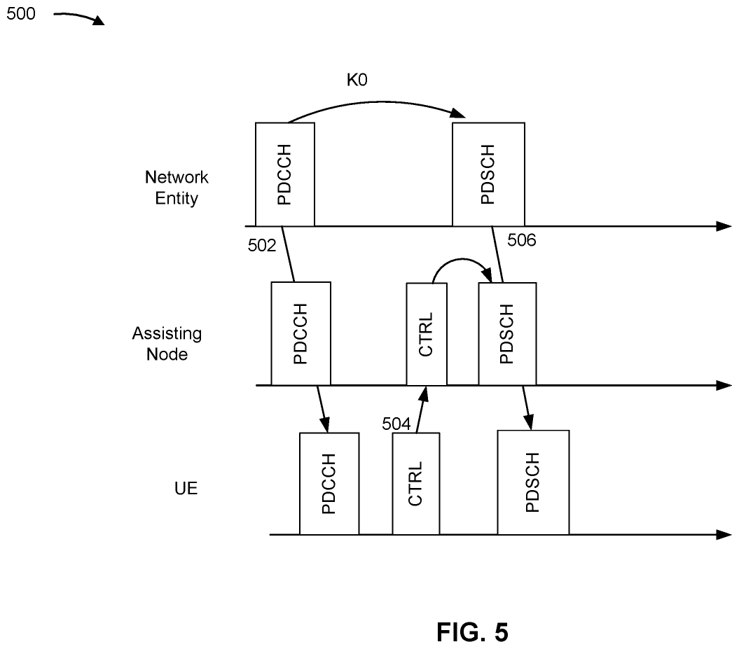

FIG. 5 is a diagram illustrating an example 500 of physical downlink control channel (PDCCH) scheduling of a physical downlink shared channel (PDSCH) communication to be transmitted to a UE via an assisting node, in accordance with the present disclosure.

In some examples, a network entity may transmit, to a UE, a PDCCH communication that includes downlink control information (DCI) (e.g., DCI format 1_1 or DCI format 1_0) that schedules a downlink communication (e.g., a PDSCH communication) to be transmitted to the UE. The DCI may indicate a K0 value. The K0 value is a time offset between the PDCCH communication and the PDSCH communication scheduled by the PDCCH communication. In some examples, UEs may support a minimum K0 value of K0=0. In some examples, the K0 value may be indicated in the DCI using an index (e.g., a 2-bit index) that maps to a set of RRC configured K0 values per bandwidth part (BWP). In some examples, a minimum scheduling offset for K0 (e.g., a minimum K0 value) may be configured for the UE for UE power saving. In this case, the UE may indicate, to the network entity (e.g., via an RRC message), a preferred K0 per sub-carrier spacing (SCS) (e.g., via preferredK0-SCS-60 kHz). For example, a range of values that may be indicated for the preferred K0 may include 2, 4, 8, or 12 slots (e.g., for 60 kHz and 120 kHz). The network entity may configure the minimum K0 value for the UE. In some examples, the network entity may indicate (e.g., via an RRC message) one or two configured minimum K0 values (e.g., minimumSchedulingOffsetKO) per BWP. For example, a range for the configured minimum K0 value(s) may be 0-16 slots. In some examples, a minimum applicable scheduling offset indicator field in the DCI may activate/indicate the relevant configured minimum K0 value.

The DCI (e.g., DCI format 1_1 or DCI format 1_0) that schedules a downlink communication (e.g., a PDSCH communication) may also indicate a K1 value. The K1 value is a time offset between the scheduled PDSCH communication and transmission of hybrid automated repeat request (HARQ) feedback (e.g., acknowledgement (ACK) or negative acknowledgment (NACK) (ACK/NACK) feedback). In some examples, there may be two types PDSCH processing capabilities (e.g., type 1 and type 2) that may be indicated (e.g., in UE capability information) for UEs. For example, type 1 may be a basic PDSCH processing capability, and type 2 may be a PDSCH processing capability associated with faster UE processing. The PDSCH processing capability of the UE may be associated with a number (N1) of OFDM symbols required for UE processing from the end of PDSCH reception to the earliest possible start of the corresponding ACK/NACK transmission by the UE. The network entity may determine the K1 value for the feedback for a scheduled PDSCH communication, and the network entity may indicate the K1 value in the DCI. In some examples, a set of K1 values per BWP may be semi-statically configured (e.g., via RRC), and the DCI may include an indication (e.g., a 0 or 3-bit indication) that maps to a K1 value of the set of configured K1 values and indicates the slot and symbols for the HARQ ACK/NACK transmission.

In some examples, a network entity may transmit, to a UE, a PDCCH communication that includes DCI (e.g., DCI format 0_1 or DCI format 0_0) that schedules an uplink communication (e.g., a physical uplink shared channel (PUSCH) communication) to be transmitted by the UE. The DCI may indicate a K2 value. The K2 value is a time offset between the PDCCH communication and the PUSCH communication scheduled by the PDCCH communication. In some examples, there may be two types of PUSCH processing capabilities (e.g., type 1 and type 2) that may be indicated (e.g., in UE capability information) for UEs. For example, type 1 may be a basic PUSCH processing capability, and type 2 may be a PUSCH processing capability associated with faster UE processing. The PUSCH processing capability of the UE may be associated with a number (N2) of OFDM symbols required for UE processing from the end of reception of the PDCCH communication including an uplink grant (e.g., DCI scheduling a PUSCH communication) to the earliest possible start of the corresponding PUSCH transmission by the UE. The network entity may determine the K2 value for the scheduled PUSCH communication, and the network entity may indicate the K2 value in the DCI. In some examples, a set of K2 values per BWP may be semi-statically configured (e.g., via RRC), and the DCI may include an indication (e.g., a 3-bit indication) that maps to a K2 value of the set of configured K2 values. In some examples, a minimum scheduling offset for K2 (e.g., a minimum K2 value) may be configured for the UE for UE power saving. In this case, the UE may indicate, to the network entity (e.g., via an RRC message) a preferred K2 per SCS (e.g., via preferredK2-SCS-60 kHz). For example, a range of values that may be indicated for the preferred K2 may include 2, 4, 8, or 12 slots (e.g., for 60 kHz and 120 kHz). The network entity may configure the minimum K2 value for the UE. In some examples, the network entity may indicate (e.g., via an RRC message) one or two configured minimum K2 values (e.g., minimumSchedulingOffsetK2) per BWP. For example, a range for the configured minimum K2 value(s) may be 0-16 slots. In some examples, a minimum applicable scheduling offset indicator field in the DCI may activate/indicate the relevant configured minimum K2 value.

In some examples, when an assisting node is involved in end-to-end (E2E) communications between a network entity and a UE, a configuration of one or more parameters (e.g., beamforming, power, bandwidth, and/or transmission/reception timing reference parameters, among other examples) of the assisting node may be dynamically adjusted and/or the assisting node may be activated. As a result, E2E processing may be slower for communications between a UE and a network entity via an assisting node than for communications via a direct link between the UE and the network entity. In some examples, larger scheduling gap parameters (e.g., K0, K1, and/or K2 values) may be needed for communications via an assisting node than for communications via a direct link between a UE and a network entity.

As shown in FIG. 5, example 500 shows an example of PDCCH scheduling of a PDSCH communication to be transmitted from a network entity to a UE via an assisting node. As shown in example 500, the assisting node may be controlled by the UE. As shown by reference number 502, the network entity may transmit, to the UE, a PDCCH communication that schedules a PDSCH communication. For example, the network entity may transmit the PDCCH communication to the UE via the assisting node. The PDCCH communication may include DCI that indicates a K0 value for the scheduled PDSCH communication (e.g., a time offset between the PDCCH communication and the scheduled PDSCH communication). As shown by reference number 504, the UE may transmit a control signal to the assisting node (e.g., via a control interface between the UE and the assisting node) to configure (or reconfigure) the assisting node for forwarding the scheduled PDSCH communication. As shown by reference number 506, the network entity may transmit the scheduled PDSCH communication, in accordance with the K0 value. The assisting node may forward (or redirect) the PDSCH communication to the UE. In this case, if the K0 value order is not large enough for the UE to have time to transmit the control signal to the assisting node, the assisting node may not reliably forward to the scheduled PDSCH communication to the UE.

In some examples, the network entity may control the assisting node. In such examples, the K0 value may need to be large enough for the network entity to configure (or reconfigure) the assisting node to forward the scheduled PDSCH communication. In some examples, the assisting node may have the capability to process a PDCCH transmitted to a UE via the assisting node, and the assisting node may not receive an explicit control signal from the UE or the network entity. However, even in such examples, the assisting node may require more time than the UE to process the PDCCH and prepare for forwarding scheduled communication. Accordingly, a larger K0 value may be beneficial in cases in which the scheduled communication is to be transmitted via the assisting node. Similarly, larger K1 and/or K2 values may be beneficial in cases in which the corresponding communications are to be transmitted via the assisting node. In a case in which the communication path between a UE and a network entity switches between a path associated with a direct link between the UE and the network entity and a path associated with communication via an assisting node, the scheduling gap parameters (e.g., K0, K1, and/or K2) used for communications via the direct link may result in unreliable communications via the assisting node.

Some techniques and apparatuses described herein enable a UE to transmit, to a network entity, an indication of a required minimum value for a time offset (e.g., K0, K1, and/or K2) associated with a communication with the network entity. In some aspects, the required minimum value for the time offset may be associated with communicating with the network entity via an assisting node. The UE may receive, from the network entity, an indication of an offset value for the time offset based at least in part on the required minimum value for the time offset, and the UE may communicate with the network entity via the assisting node in accordance with the offset value indicated. As a result, when the UE and the network entity are communicating via a path that includes the assisting node, the network entity may indicate a time offset value sufficient for communications via the assisting node, even in a case in which the assisting node is not visible to the network entity. This may result in increased reliability of communications between the UE and the network entity via the assisting node.

Some techniques and apparatuses described herein enable a network entity to transmit, and a UE may receive, a configuration of a plurality of sets of offset values (e.g., K0 values, K1 values, and/or K2 values) for a BWP, for a time offset associated with a communication between the network entity and the UE. For example, the plurality of sets of offset values may include at least a first set of offset values associated with communication between the network entity and the UE without an assisting node (e.g., via a direct link) and a second set of offset values associated with communication between the network entity and the UE via an assisting node. The network entity may transmit, and the UE may receive, an indication of an offset value, in a set of offset values of the plurality of sets of offset values, for the time offset, and the UE and the network entity may communicate in accordance with the offset value indicated. In some aspects, in a case in which a communication is scheduled via a path that includes an assisting node, the network entity may indicate an offset value in a set of offset values associated with communication between the UE and the network entity via the assisting node. As a result, the offset value for the scheduled communication may be sufficient for communications via the assisting node, which may result in increased reliability of communications between the UE and the network entity via the assisting node.

As indicated above, FIG. 5 is provided as an example. Other examples may differ from what is described with respect to FIG. 5.

FIG. 6 is a diagram illustrating an example 600 associated with dynamic path switching via an assisting node, in accordance with the present disclosure. As shown in FIG. 6, example 600 includes a network entity 602 (e.g., base station 110, CU 310, DU 330, RU 340, or a combination thereof), a UE 120, and an assisting node 604. In some aspects, the network entity 602, the UE 120, and the assisting node 604 may be included in a wireless network, such as wireless network 100. The network entity 602 and the UE 120 may communicate via a direction link or via the assisting node 604.

In some aspects, the assisting node 604 may be a repeater, a relay, or an RIS. In some aspects, the assisting node 604 may be visible to the UE 120 (e.g., the UE 120 may be aware of which path/beam is associated with communications between the UE 120 and the network entity 602 via the assisting node 604), and the UE 120 may control the assisting node 604 (e.g., via a control interface between the UE 120 and the assisting node 604). In some aspects, the assisting node 604 may be visible to the UE 120 and the network entity 602, and the assisting node 604 may be controlled by the UE 120, by the network entity 602, or jointly by the UE 120 and the network entity 602.

As shown in FIG. 6, and by reference number 605, the UE 120 may transmit, and the network entity 602 may receive, an indication of a required minimum value for each of one or more scheduling gap parameters. Each scheduling gap parameter may be a time offset associated with a communication between the UE 120 and the network entity 602. In some aspects, the one or more scheduling gap parameters (e.g., time offsets) may include a K0 parameter (e.g., a time offset associated with a downlink communication), a K1 parameter (e.g., a time offset associated with HARQ feedback for a downlink communication), and/or a K2 parameter (e.g., a time offset associated with an uplink communication). For example, the UE 120 may transmit, to the network entity 602, an indication of a required minimum K0 value, a required minimum K1 value, and/or a required minimum K2 value. In some aspects, the UE 120 may transmit the indication of the required minimum value(s) to the network entity 602 via a direct link between the UE 120 and the network entity 602. In some aspects, the UE 120 may transmit the indication of the required minimum value(s) to the network entity 602 via the assisting node 604. In this case, the assisting node 604 may forward and/or redirect the communication including the indication of the required minimum value(s) to the network entity 602.

In some aspects, the UE 120 may transmit, and the network entity 602 may receive, an indication of a required minimum value, for a time offset (e.g., K0, K2, or K3), that is associated with communication with the network entity 602 via the assisting node 604. In some aspects, the required minimum value for the time offset is a beam-specific required minimum value associated with a beam used by the UE 120 for communicating with the network entity 602 via the assisting node 604. In some aspects, the indication of the required minimum value for the time offset may be a dynamic indication (e.g., included in uplink control information (UCI) or a MAC control element (MAC-CE)). For example, the UE 120 may transmit the indication of the required minimum value for the time offset in connection with switching between a first communication path between the UE 120 and the network entity 602 (e.g., associated with a direct link between the UE 120 and the network entity 602) and a second communication path between the UE 120 and the network entity 602 (e.g., associated with communicating with the network entity 602 via the assisting node 604). In some aspects, the required minimum value for the time offset may be associated with time and/or frequency resources associated with communicating with the network entity 602 via the assisting node 604. In some aspects, the required minimum value for the time offset may be associated with a multiplexing mode associated with communicating with the network entity 602 via the assisting node 604. In some aspects, the required minimum value for the time offset is associated with an assisting node identifier associated with the assisting node 604.

In some aspects, the UE 120 may transmit, and the network entity 602 may receive, an indication of a required minimum K0 value for the UE 120. The required minimum K0 value may be a required minimum time offset between a PDCCH communication that schedules a downlink communication (e.g., PDSCH communication) to be transmitted to the UE 120 and the downlink communication (e.g., PDSCH communication) scheduled by the PDCCH communication. The indication of the required minimum K0 value may be different from an indication of the preferred K0 value for the UE 120 (e.g., for UE power saving). For example, the required minimum K0 value may be provided in a separate indication from the preferred K0 value, and the indicated required minimum K0 value may be different from the preferred K0 value. In some aspects, a range of values that the UE 120 may indicate for the required minimum K0 value may be different from the range of values that the UE 120 may indicate for the preferred K0 value. For example, the range of value for the required minimum K0 value (e.g., 1-16 slots or 1-32 slots) may be larger and/or more granular than the range of values for the preferred K0 value. In some aspects, the required minimum K0 value for the UE 120 may be a minimum K0 value required for a path used for communication between the UE 120 and the network entity 602 (e.g., a path associated with a direct link or a path associated with communication between the UE 120 and the network entity 602 via the assisting node 604). In some aspects, the network entity 602 may be required to select a K0 value for a scheduled downlink communication that satisfies (e.g., is greater than or equal to) the required minimum K0 value indicated by the UE 120.

In some aspects, the UE 120 may transmit, and the network entity 602 may receive, an indication of a required minimum K0 value associated with communication between the UE 120 and the network entity 602 via the assisting node 604. For example, the UE 120 may transmit the indication of the required minimum K0 value associated with communication via the assisting node 604 in connection with a path (or beam) for communicating with the network entity 602 dynamically switching to a path (or beam) associated communicating with the network entity 602 via the assisting node 604 (e.g., from a path associated with a direct link between the UE 120 and the network entity 602 or a path associated with communicating with the network entity 602 via another assisting node).

In some aspects, the indication of the required minimum K0 value may be beam-specific. For example, the indicated required minimum K0 value may be associated with a transmission configuration indicator (TCI) state that identifies a downlink beam (e.g., a receive beam) of the UE 120 or a downlink reference signal identifier (ID) that identifies a downlink beam of the UE 120. In some aspects, the required minimum K0 value for communication via the assisting node 604 may be associated with a beam used by the UE 120 for communicating with the network entity 602 via the assisting node 604. When scheduling a downlink communication on a beam (e.g., the beam use for communication via the assisting node 604), the network entity 602 may be required to select a K0 value that satisfies the required minimum K0 value associated with that beam. In this way, the network entity 602 may select a K0 value that satisfies the required minimum K0 value associated with communication via the assisting node 604, even in a case in which the assisting node 604 is not visible to or controlled by the network entity 602.

In some aspects, the indication of the required minimum K0 value may be a dynamic indication of a required minimum K0 value (or a dynamic indication of a change to a previously indicated required minimum K0 value). For example, the dynamic indication of the required minimum K0 value may be included UCI (e.g., in a physical uplink control channel (PUCCH) communication) or a MAC-CE. In some aspects, the UE 120 may transmit the dynamic indication of the required minimum K0 value in connection with dynamically switching between a first communication path between the UE 120 and the network entity 602 and a second communication path between the UE 120 and the network entity 602. For example, in connection with switching to a path (or beam) associated with communication with the network entity 602 via the assisting node 604 (e.g., from a path associated with a direct link between the UE 120 and the network entity 602 or from a path associated with communication via another assisting node), the UE 120 may transmit a dynamic indication of the required minimum K0 value associated with communication via the assisting node 604. In connection with switching to a path (or beam) associated with a direct link between the UE 120 and the network entity 602 from a path (or beam) associated with communication via the assisting node 604, the UE 120 may transmit a dynamic indication of a required minimum K0 value associated with communication via the direct link. In this case, the required minimum K0 value associated with communication via the direct link may be less than the required minimum K0 value associated with communication via the assisting node 604. For example, the required minimum K0 value associated with communication via the direct link may be equal to 0, and the required minimum K0 value associated with communication via the assisting node 604 may be greater than 0.

In some aspects, the required minimum K0 value may be associated with one or more time resources (e.g., slot index) and/or frequency resources (e.g., resource blocks (RBs)). For example, the assisting node 604 may be available to serve the UE 120 in only a subset of occasions (e.g., a subset of slots and/or RBs of a set of available slots and/or RBs). In this case, the required minimum K0 value for communication via the assisting node 604 may be associated with the time and/or frequency resources in which the assisting node 604 is available to serve the UE 120. When scheduling a downlink communication to be transmitted to the UE 120, the network entity 602 may be required to select a K0 value that satisfies the required minimum K0 value indicated for the time and/or frequency resources in which the downlink communication is scheduled.

In some aspects, the required minimum K0 value may be associated with a multiplexing mode (e.g., half-duplex or full-duplex). For example, the required minimum K0 value for communication via the assisting node 604 may be associated with a multiplexing mode used for communications via the assisting node 604. In this case, when scheduling a downlink communication to be transmitted to the UE 120, the network entity 602 may be required to select a K0 value that satisfies the required minimum K0 value associated with the multiplexing mode to be used for the downlink communication. In some aspects, the UE 120 may indicate respective required minimum K0 values associated with one or more multiplexing modes.

In some aspects, the UE 120 may indicate respective required minimum K0 values associated with one or more assisting node IDs. An assisting node ID (e.g., a repeater ID) may identify an assisting node. For example, the indication of the required minimum K0 value may include an indication of a required minimum K0 value associated with an assisting node ID that identifies the assisting node 604. In this case, the assisting node 604 may be visible to the UE 120 and the network entity 602, and, for a downlink communication to be transmitted via the assisting node 604, the network entity 602 may select a K0 value via that satisfies the required minimum K0 value associated with the assisting node ID that identifies the assisting node 604. In some aspects, the UE 120 may indicate respective required minimum K0 values associated with one or more assisting node IDs that identify respective assisting nodes and/or a required minimum K0 value associated with a default assisting node ID value that is used for communication without an assisting node (e.g., via a direct link between the UE 120 and the network entity 602).

In some aspects, a PDSCH communication may be transmitted (e.g., by the network entity 602) to the UE 120 via a different beam than the PDCCH communication that schedules the PDSCH communication. In this case, the PDCCH communication may indicate the TCI state that identifies the beam for the scheduled PDSCH communication. The UE 120 may indicate, to the network entity 602 (e.g., in UE capability information), a time duration for quasi co-location (QCL) (e.g., timeDurationforQCL) for the UE 120. The time duration for QCL may identify a minimum number of OFDM symbols for the UE 120 to perform PDCCH reception and apply the spatial QCL information indicated in the DCI included in a PDCCH communication to switch beams for receiving the scheduled PDSCH communication. In some aspects, the UE 120 may transmit, and the network entity 602 may receive, an indication of an adjusted time duration for QCL. For example, the UE 120 may transmit an indication an adjusted time duration for QCL in connection with a first beam (e.g., a PDCCH beam) on which the PDCCH communication is received and/or a second beam (e.g., a PDSCH beam) on which the PDSCH communication is received being associated with communication via the assisting node 604.

In some aspects, the indication of the adjust time duration for QCL may be beam-specific. For example, an indicated adjusted time duration for QCL value may be associated with a TCI state or a downlink reference signal ID that identifies downlink beam of the UE 120. In some aspects, the adjusted time duration for QCL may be beam-pair-specific. For example, the indicated adjusted time duration for QCL may be associated with a beam pair including a PDCCH beam and a PDSCH beam. In some aspects, a first adjusted time duration for QCL (e.g., to allow for time to configure the assisting node 604 for forwarding the PDSCH communication) may be associated with a beam pair that includes a PDCCH beam associated with a direct link between the UE 120 and the network entity 602 and a PDSCH beam associated with communication via the assisting node 604. In some aspects, the time duration for QCL or a second adjusted time duration for QCL (e.g., to allow for time to deactivate or dissociate the assisting node 604) may be associated with a beam pair that includes a PDCCH beam associated with communication via the assisting node 604 and a PDSCH beam associated with a direct link between the UE 120 and the network entity 602. In some aspects, a third adjusted time duration for QCL (e.g., to allow for beam changes for a receive beam of the UE 120, a receive beam of the assisting node 604, a transmit beam of the assisting node 604, or a combination thereof) may be associated with a beam pair including a PDCCH beam that is a first beam associated with communication via the assisting node 604 and a PDSCH beam that is a second beam associated with communication via the assisting node 604. In this case, the third adjusted time duration for QCL may be based at least in part on the pair of beams associated with communication via the assisting node 604. In some aspects, a fourth adjusted time duration for QCL may be associated with a beam pair that includes a PDCCH beam associated with communication via a first assisting node and a PDSCH beam associated with communication via a second assisting node. In this case, the fourth adjusted time duration for QCL may be based at least in part on the pair of assisting nodes and the beam changes for the UE 120.

In some aspects, the indication of the adjusted time duration for QCL may be a dynamic indication (e.g., transmitted via UCI or a MAC-CE). In some aspects, the adjusted time duration for QCL may be associated with one or more time resources (e.g., slot index) and/or frequency resources (e.g., RBs or BWPs). In some aspects, the adjusted time duration for QCL may be associated with a multiplexing mode (e.g., half-duplex or full-duplex). In some aspects, the UE 120 may indicate respective adjusted time duration for QCL values associated with one or more multiplexing modes. In some aspects, the adjusted time duration for QCL may be associated with an assisting node 604 identifier. In some aspects, the UE 120 may indicate respective adjusted time duration for QCL values associated with one or more assisting node IDs.

In some aspects, the UE 120 may transmit, and the network entity 602 may receive, an indication of a required minimum K1 value for the UE 120. The required minimum K1 value may be a required minimum time offset between a scheduled downlink communication (e.g., PDSCH communication) to be transmitted to the UE 120 and a scheduled HARQ feedback transmission for the scheduled downlink communication. In some aspects, the required minimum K1 value for the UE 120 may be a minimum K1 value required for a path used for communication between the UE 120 and the network entity 602 (e.g., a path associated with a direct link or a path associated with communication between the UE 120 and the network entity 602 via the assisting node 604). In some aspects, for a path associated with communication between the UE 120 and the network entity 602 via the assisting node 604, the required minimum K1 value may be greater than N1 (e.g., the number of OFDM symbols associated with the PDSCH processing capability of the UE 120). In some aspects, the indication of the required minimum K1 value may be independent from an indication of PDSCH processing capability for the UE 120. In some aspects, the UE 120 may indicate an adjusted value for N1 associated with a path for communication via the assisting node 604. In some aspects, the UE 120 may indicate the required minimum K1 value via an indication of an additional latency offset to be combined with N1. In some aspects, the network entity 602 may be required to select a K1 value for the feedback for a scheduled downlink communication that satisfies (e.g., is greater than or equal to) the required minimum K1 value indicated by the UE 120.

In some aspects, the UE 120 may transmit, and the network entity 602 may receive, an indication of a required minimum K1 value associated with communication between the UE 120 and the network entity 602 via the assisting node 604. For example, the UE 120 may transmit the indication of the required minimum K1 value associated with communication via the assisting node 604 in connection with a path (or beam) for communicating with the network entity 602 dynamically switching to a path (or beam) associated communicating with the network entity 602 via the assisting node 604 (e.g., from a path associated with a direct link between the UE 120 and the network entity 602 or a path associated with communicating with the network entity 602 via another assisting node).

In some aspects, the indication of the required minimum K1 value may be beam-specific. For example, the indicated required minimum K1 value may be associated with a TCI state that identifies a downlink beam (e.g., a receive beam) of the UE 120 or a downlink reference signal ID that identifies a downlink beam of the UE 120. In some aspects, the required minimum K1 value for communication via the assisting node 604 may be associated with a beam used by the UE 120 for communicating with the network entity 602 via the assisting node 604.

In some aspects, the indication of the required minimum K1 value may be a dynamic indication of a required minimum K1 value (or a dynamic indication of a change to a previously indicated required minimum K1 value). For example, the dynamic indication of the required minimum K1 value may be included in UCI (e.g., in a PUCCH communication) or a MAC-CE. In some aspects, the UE 120 may transmit the dynamic indication of the required minimum K1 value in connection with dynamically switching between a first communication path between the UE 120 and the network entity 602 and a second communication path between the UE 120 and the network entity 602. For example, in connection with switching to a path (or beam) associated with communication with the network entity 602 via the assisting node 604 (e.g., from a path associated with a direct link between the UE 120 and the network entity 602 or from a path associated with communication via another assisting node), the UE 120 may transmit a dynamic indication of the required minimum K1 value associated with communication via the assisting node 604. In connection with switching to a path (or beam) associated with a direct link between the UE 120 and the network entity 602 from a path (or beam) associated with communication via the assisting node 604, the UE 120 may transmit a dynamic indication of a required minimum K1 value associated with communication via the direct link. In this case, the required minimum K1 value associated with communication via the direct link may be less than the required minimum K1 value associated with communication via the assisting node 604.

In some aspects, the required minimum K1 value may be associated with one or more time resources (e.g., slot index) and/or frequency resources (e.g., RBs). For example, the assisting node 604 may be available to serve the UE 120 in only a subset of occasions (e.g., a subset of slots and/or RBs of a set of available slots and/or RBs). In this case, the required minimum K1 value for communication via the assisting node 604 may be associated with the time and/or frequency resources in which the assisting node 604 is available to serve the UE 120.

In some aspects, the required minimum K1 value may be associated with a multiplexing mode (e.g., half-duplex or full-duplex). For example, the required minimum K1 value for communication via the assisting node 604 may be associated with a multiplexing mode used for communications via the assisting node 604. In some aspects, the UE 120 may indicate respective required minimum K1 values associated with one or more multiplexing modes.

In some aspects, the UE 120 may indicate respective required minimum K1 values associated with one or more assisting node IDs. For example, the indication of the required minimum K1 value may include an indication of a required minimum K1 value associated with an assisting node ID that identifies the assisting node 604. In some aspects, the UE 120 may indicate respective required minimum K1 values associated with one or more assisting node IDs that identify respective assisting nodes and/or a required minimum K1 value associated with a default assisting node ID value that is used for communication without an assisting node (e.g., via a direct link between the UE 120 and the network entity 602).

In some aspects, the UE 120 may transmit, and the network entity 602 may receive, an indication of a required minimum K2 value for the UE 120. The required minimum K2 value may be a required minimum time offset between a PDCCH communication that schedules an uplink communication (e.g., PUSCH communication) to be transmitted by the UE 120 and the uplink communication (e.g., PUSCH communication) scheduled by the PDCCH communication. The indication of the required minimum K2 value may be different from an indication of the preferred K2 value for the UE 120 (e.g., for UE power saving). For example, the required minimum K2 value may be provided in a separate indication from the preferred K2 value, and the indicated required minimum K2 value may be different from the preferred K2 value. In some aspects, a range of values that the UE 120 may indicate for the required minimum K2 value may be different from the range of values that the UE 120 may indicate for the preferred K2 value. For example, the range of value for the required minimum K2 value (e.g., 1-16 slots or 1-32 slots) may be larger and/or more granular than the range of values for the preferred K2 value.

In some aspects, the required minimum K2 value for the UE 120 may be a minimum K2 value required for a path used for communication between the UE 120 and the network entity 602 (e.g., a path associated with a direct link or a path associated with communication between the UE 120 and the network entity 602 via the assisting node 604). In some aspects, for a path associated with communication between the UE 120 and the network entity 602 via the assisting node 604, the required minimum K2 value may be greater than N2 (e.g., the number of OFDM symbols associated with the PUSCH processing capability of the UE 120). In some aspects, the indication of the required minimum K2 value may be independent from an indication of PUSCH processing capability for the UE 120. In some aspects, the UE 120 may indicate an adjusted value for N2 associated with a path for communication via the assisting node 604. In some aspects, the UE 120 may indicate the required minimum K2 value via an indication of an additional latency offset to be combined with N2. In some aspects, the network entity 602 may be required to select a K2 value for a scheduled uplink communication that satisfies (e.g., is greater than or equal to) the required minimum K2 value indicated by the UE 120.

In some aspects, the UE 120 may transmit, and the network entity 602 may receive, an indication of a required minimum K2 value associated with communication between the UE 120 and the network entity 602 via the assisting node 604. For example, the UE 120 may transmit the indication of the required minimum K2 value associated with communication via the assisting node 604 in connection with a path (or beam) for communicating with the network entity 602 dynamically switching to a path (or beam) associated communicating with the network entity 602 via the assisting node 604 (e.g., from a path associated with a direct link between the UE 120 and the network entity 602 or a path associated with communicating with the network entity 602 via another assisting node).

In some aspects, the indication of the required minimum K2 value may be beam-specific. For example, the indicated required minimum K2 value may be associated with a downlink beam of the UE 120 used for receiving a PDCCH communication, an uplink beam of the UE 120 used for transmitting a PUSCH communication, or a combination thereof. In some aspects, the required minimum K2 value for communication via the assisting node 604 may be associated with a beam used by the UE 120 for communicating with the network entity 602 via the assisting node 604. When scheduling an uplink communication on a beam (e.g., the beam use for communication via the assisting node 604), the network entity 602 may be required to select a K2 value that satisfies the required minimum K2 value associated with that beam. In this way, the network entity 602 may select a K2 value that satisfies the required minimum K2 value associated with communication via the assisting node 604, even in a case in which the assisting node 604 is not visible to or controlled by the network entity 602.

In some aspects, the indication of the required minimum K2 value may be a dynamic indication of a required minimum K2 value (or a dynamic indication of a change to a previously indicated required minimum K2 value). For example, the dynamic indication of the required minimum K2 value may be included in UCI (e.g., in a PUCCH communication) or a MAC-CE. In some aspects, the UE 120 may transmit the dynamic indication of the required minimum K2 value in connection with dynamically switching between a first communication path between the UE 120 and the network entity 602 and a second communication path between the UE 120 and the network entity 602. For example, in connection with switching to a path (or beam) associated with communication with the network entity 602 via the assisting node 604 (e.g., from a path associated with a direct link between the UE 120 and the network entity 602 or from a path associated with communication via another assisting node), the UE 120 may transmit a dynamic indication of the required minimum K2 value associated with communication via the assisting node 604. In connection with switching to a path (or beam) associated with a direct link between the UE 120 and the network entity 602 from a path (or beam) associated with communication via the assisting node 604, the UE 120 may transmit a dynamic indication of a required minimum K2 value associated with communication via the direct link. In this case, the required minimum K2 value associated with communication via the direct link may be less than the required minimum K2 value associated with communication via the assisting node 604. For example, the required minimum K2 value associated with communication via the direct link may be equal to N2, and the required minimum K2 value associated with communication via the assisting node 604 may be greater than N2.

In some aspects, the required minimum K2 value may be associated with one or more time resources (e.g., slot index) and/or frequency resources (e.g., RBs). For example, the assisting node 604 may be available to serve the UE 120 in only a subset of occasions (e.g., a subset of slots and/or RBs of a set of available slots and/or RBs). In this case, the required minimum K2 value for communication via the assisting node 604 may be associated with the time and/or frequency resources in which the assisting node 604 is available to serve the UE 120. When scheduling an uplink communication to be transmitted to the UE 120, the network entity 602 may be required to select a K2 value that satisfies the required minimum K2 value indicated for the time and/or frequency resources in which the uplink communication is scheduled.

In some aspects, the required minimum K2 value may be associated with a multiplexing mode (e.g., half-duplex or full-duplex). For example, the required minimum K2 value for communication via the assisting node 604 may be associated with a multiplexing mode used for communications via the assisting node 604. In this case, when scheduling an uplink communication to be transmitted to the UE 120, the network entity 602 may be required to select a K2 value that satisfies the required minimum K2 value associated with the multiplexing mode to be used for the uplink communication. In some aspects, the UE 120 may indicate respective required minimum K2 values associated with one or more multiplexing modes.

In some aspects, the UE 120 may indicate respective required minimum K2 values associated with one or more assisting node IDs. For example, the indication of the required minimum K2 value may include an indication of a required minimum K2 value associated with an assisting node ID that identifies the assisting node 604. In this case, the assisting node 604 may be visible to the UE 120 and the network entity 602, and, for an uplink communication to be transmitted via the assisting node 604, the network entity 602 may select a K2 value via that satisfies the required minimum K2 value associated with the assisting node ID that identifies the assisting node 604. In some aspects, the UE 120 may indicate respective required minimum K2 values associated with one or more assisting node IDs that identify respective assisting nodes and/or a required minimum K2 value associated with a default assisting node ID value that is used for communication without an assisting node (e.g., via a direct link between the UE 120 and the network entity 602).

In some aspects, the UE 120 may transmit, and the network entity 602 may receive, an indication for a required minimum value for a time offset between a PDCCH communication scheduling (e.g., triggering) an aperiodic downlink reference signal (e.g., an aperiodic channel state information (CSI) reference signal (CSI-RS)) and the scheduled aperiodic downlink reference signal (e.g., the aperiodic CSI-RS). For example, the required minimum value may be a required minimum value associated with a path (or beam) for the PDCCH communication and/or the aperiodic downlink reference signal being associated with communication via the assisting node 604. The UE 120 may indicate the required minimum value for the time offset for the aperiodic downlink reference signal similarly to as described above in connection with K0, K1, and/or K3.

In some aspects, the UE 120 may transmit, and the network entity 602 may receive, an indication for a required minimum value for a time offset between a PDCCH communication scheduling (e.g., triggering) an aperiodic uplink reference signal (e.g., an aperiodic sounding reference signal (SRS)) and the scheduled aperiodic uplink reference signal (e.g., the aperiodic SRS). For example, the required minimum value may be a required minimum value associated with a path (or beam) for the PDCCH communication and/or the aperiodic uplink reference signal being associated with communication via the assisting node 604. The UE 120 may indicate the required minimum value for the time offset for the aperiodic uplink reference signal similarly to as described above in connection with K0, K1, and/or K3.

As further shown in FIG. 6, and by reference number 610, in some aspects, the network entity 602 may transmit, and the UE 120 may receive, a configuration of a minimum K0 and/or a minimum K2 for the UE 120. For example, the configuration of the minimum K0 and/or the minimum K2 may be included in an RRC message (or multiple RRC messages). In some aspects, the network entity 602 may transmit the configuration of the minimum K0 and/or the minimum K2 to the UE 120 via a direct link between the network entity 602 and the UE 120. In some aspects, the network entity 602 may transmit the configuration of the minimum K0 and/or the minimum K2 to the UE 120 via the assisting node 604. In this case, the assisting node 604 may forward or redirect the communication (e.g., RRC message) including the configuration of the minimum K0 and/or the minimum K2 value to the UE 120.

In some aspects, the configuration of the minimum K0 and/or the minimum K2 may be based at least in part on the indication of the required minimum values for K0 and/or K2 transmitted to the network entity 602 by the UE 120. In some aspects, the configuration of the minimum K0 and/or the minimum K2 may be independent of the indication of the required minimum values for K0 and K2 transmitted by the UE 120.

In some aspects, the network entity 602 may repurpose the minimum K0 indication to indicate an extended minimum K0 value to be used for communications between the UE 120 and the network entity 602 via the assisting node 604 (and/or other assisting nodes). In some aspects, configuration of the minimum K0 may indicate more than two configured values for the minimum K0 for the UE 120. In some aspects, the configuration of the minimum K0 may indicate multiple sets of configured minimum K0 values per BWP (e.g., for one or more BWPs). In some aspects, respective sets configured minimum K0 values, of the multiple sets of configured minimum K0 values, may be associated with respective beams, respective time and/or frequency resources, respective radio network temporary identifiers (RNTIs), respective control resource sets (CORESETs), respective TRPs (e.g., respective CORESET pools), respective multiplexing modes, respective MIMO layers, and/or respective assisting node IDs. The multiple sets of configured minimum K0 values may include at least a first set of configured minimum K0 values associated with communication between the UE 120 and the network entity 602 without an assisting node (e.g., via a direct link) and a second set of configured minimum K0 values associated with communication between the UE 120 and the network entity 602 via the assisting node 604. The multiple sets of configured minimum K0 values may also include one or more other sets of configured minimum K0 values associated with communication between the UE 120 and the network entity 602 via one or more other assisting nodes.

In some aspects, the network entity 602 may repurpose the minimum K2 indication to indicate an extended minimum K2 value to be used for communications between the UE 120 and the network entity 602 via the assisting node 604 (and/or other assisting nodes). In some aspects, configuration of the minimum K2 may indicate more than two configured values for the minimum K2 for the UE 120. In some aspects, the configuration of the minimum K2 may indicate multiple sets of configured minimum K2 values per BWP (e.g., for one or more BWPs). In some aspects, respective sets configured minimum K2 values, of the multiple sets of configured minimum K2 values, may be associated with respective beams, respective time and/or frequency resources, respective RNTIs, respective CORESETs, respective TRPs (e.g., respective CORESET pools), respective multiplexing modes, respective MIMO layers, and/or respective assisting node IDs. The multiple sets of configured minimum K2 values may include at least a first set of configured minimum K2 values associated with communication between the UE 120 and the network entity 602 without an assisting node (e.g., via a direct link) and a second set of configured minimum K2 values associated with communication between the UE 120 and the network entity 602 via the assisting node 604. The multiple sets of configured minimum K2 values may also include one or more other sets of configured minimum K2 values associated with communication between the UE 120 and the network entity 602 via one or more other assisting nodes.

As further shown in FIG. 6, and by reference number 615, in some aspects, the network entity 602 may transmit, and the UE 120 may receive a PDCCH communication that schedules a downlink communication (e.g., a PDSCH communication or a downlink reference signal). In some aspects, the PDCCH communication may be transmitted from the network entity 602 to the UE 120 via the assisting node 604. In some aspects, the PDCCH communication may be transmitted from the network entity 602 to the UE 120 via a direct link between the UE 120 and the network entity 602. The PDCCH communication may include an indication of an offset value for a time offset associated with the scheduled downlink communication, and the indicated offset value may be based at least in part on the indication of the required minimum value for the time offset transmitted by the UE 120. For example, the network entity 602 may select an offset value for the time offset associated with the scheduled downlink communication that satisfies the required minimum value for the time offset indicated by the indication of the required minimum value received from the UE 120, and the network entity 602 may indicate the selected offset value in DCI included in the PDCCH.

In some aspects, the PDCCH communication may indicate a K0 value for a scheduled PDSCH communication (e.g., the time offset between the PDCCH communication and the scheduled PDSCH communication). The K0 value, indicated in the PDCCH, may satisfy the minimum required K0 value indicated in the indication transmitted by the UE 120. In some aspects, the network entity 602 may select the K0 value to satisfy the required minimum K0 value indicated in a dynamic indication received from the UE 120 (e.g., via UCI or a MAC-CE). In aspects, the network entity 602 may select the K0 value to satisfy the required minimum K0 value associated with a beam to be used for the PDSCH communication, time and/or frequency resources to be used for the PDSCH communication, a multiplexing mode to be used for the PDSCH communication, or an assisting node ID identifying an assisting node (e.g., assisting node 604) to be used to forward or redirect the PDSCH communication to the UE 120. In some aspects, in a case in which the PDCCH communication is transmitted is a first beam, and the PDSCH communication is scheduled to be transmitted using a different beam, the K0 value indicated in the PDCCH communication may also satisfy the indication of the adjusted time duration for QCL received from the UE 120.

In some aspects, the PDCCH communication may indicate a K1 value for a scheduled PDSCH communication (e.g., the time offset between the scheduled PDSCH communication and the scheduled transmission of HARQ feedback for the scheduled PDSCH communication). The K1 value, indicated in the PDCCH, may satisfy the minimum required K1 value indicated in the indication transmitted by the UE 120. In some aspects, the network entity 602 may select the K1 value to satisfy the required minimum K1 value indicated in a dynamic indication received from the UE 120 (e.g., via UCI or a MAC-CE). In aspects, the network entity 602 may select the K1 value to satisfy the required minimum K1 value associated with a beam to be used for the PDSCH communication (or the HARQ feedback transmission), time and/or frequency resources to be used for the PDSCH communication (or the HARQ feedback transmission), a multiplexing mode to be used for the PDSCH communication (or the HARQ feedback transmission), or an assisting node ID identifying an assisting node (e.g., assisting node 604) to be used to forward or redirect the PDSCH communication to the UE 120.

In some aspects, the PDCCH communication may indicate an offset value for a scheduled aperiodic downlink reference signal (e.g., aperiodic CSI-RS) transmission (e.g., the time offset between the PDCCH communication and the scheduled aperiodic CSI-RS). The offset value for the aperiodic downlink reference signal (e.g., aperiodic CSI-RS) may satisfy the minimum required value for the time offset indicated in the indication transmitted by the UE 120.

As further shown in FIG. 6, and by reference number 620, the network entity 602 may transmit, and the UE 120 may receive, the downlink communication scheduled by the PDCCH communication in accordance with the offset value indicated in the PDCCH communication (e.g., the offset value that satisfies the required minimum value for the time offset indicated by the UE 120). In some aspects, the scheduled downlink communication may be a PDSCH communication. As shown in FIG. 6, the K0 value indicated in the PDCCH communication may indicate the time offset between the PDCCH communication and the downlink communication (e.g., PDSCH communication) scheduled by the PDCCH communication. In some aspects, the downlink communication (e.g., the PDSCH communication) may be transmitted from the network entity 602 to the UE 120 via the assisting node 604. In this case, the K0 value indicated in the PDCCH communication may satisfy a required minimum K0 value (indicated by the UE 120) that is associated with communication between the UE 120 and the network entity 602 via the assisting node 604. In some aspects, the downlink communication (e.g., the PDSCH communication) may be transmitted from the network entity 602 to the UE 120 via a direct link between the network entity 602 and the UE 120. In this case, the K0 value indicated in the PDCCH communication may satisfy a required minimum K0 value (indicated by the UE 120) that is associated with communication via a direct link between the UE 120 and the network entity 602.

In some aspects, the scheduled downlink communication may be an aperiodic downlink reference signal (e.g., an aperiodic CSI-RS) transmission. In some aspects, the downlink reference signal (e.g., the CSI-RS) may be transmitted from the network entity 602 to the UE 120 via the assisting node 604. In this case, the offset value indicated in the PDCCH communication for the downlink reference signal may satisfy a required minimum time offset value (indicated by the UE 120) that is associated with communication between the UE 120 and the network entity 602 via the assisting node 604. In some aspects, the downlink reference signal (e.g., the CSI-RS) may be transmitted from the network entity 602 to the UE 120 via a direct link between the network entity 602 and the UE 120. In this case, the offset value indicated in the PDCCH communication for the downlink reference signal may satisfy a required minimum time offset value (indicated by the UE 120) that is associated with communication via a direct link between the UE 120 and the network entity 602.

As further shown in FIG. 6, and by reference number 625, the UE 120 may transmit, and the network entity 602 may receive, HARQ feedback for the downlink communication (e.g., the PDSCH communication) received by the UE 120. For example, the HARQ feedback may include a HARQ-ACK indication or a HARQ-NACK indication. As shown in FIG. 6, the K1 value indicated in the PDCCH communication may indicate the time offset between the downlink communication (e.g., the PDSCH communication) and the scheduled transmission of the HARQ feedback for the PDSCH communication. In some aspects, the HARQ feedback may be transmitted from the UE 120 to the network entity 602 via the assisting node 604. In this case, the K1 value indicated in the PDCCH communication may satisfy a required minimum K1 value (indicated by the UE 120) that is associated with communication between the UE 120 and the network entity 602 via the assisting node 604. In some aspects, the HARQ feedback may be transmitted from the UE 120 to the network entity 602 via a direct link between the UE 120 and the network entity 602. In this case, the K1 value indicated in the PDCCH communication may satisfy a required minimum K1 value (indicated by the UE 120) that is associated with communication via a direct link between the UE 120 and the network entity 602.

As further shown in FIG. 6, and by reference number 630, in some aspects, the network entity 602 may transmit, and the UE 120 may receive, a PDCCH communication that schedules an uplink communication (e.g., a PUSCH communication or an uplink reference signal) to be transmitted by the UE 120. In some aspects, the PDCCH communication may be transmitted from the network entity 602 to the UE 120 via the assisting node 604. In some aspects, the PDCCH communication may be transmitted from the network entity 602 to the UE 120 via a direct link between the UE 120 and the network entity 602. The PDCCH communication may include an indication of an offset value for a time offset associated with the scheduled uplink communication, and the indicated offset value may be based at least in part on the indication of the required minimum value for the time offset transmitted by the UE 120. For example, the network entity 602 may select an offset value for the time offset associated with the scheduled uplink communication that satisfies the required minimum value for the time offset indicated by the indication of the required minimum value received from the UE 120, and the network entity 602 may indicate the selected offset value in DCI included in the PDCCH.

In some aspects, the PDCCH communication may indicate a K2 value for a scheduled PUSCH communication (e.g., the time offset between the PDCCH communication and the scheduled PUSCH communication). The K2 value, indicated in the PDCCH, may satisfy the minimum required K2 value indicated in the indication transmitted by the UE 120. In some aspects, the network entity 602 may select the K2 value to satisfy the required minimum K2 value indicated in a dynamic indication received from the UE 120 (e.g., via UCI or a MAC-CE). In aspects, the network entity 602 may select the K2 value to satisfy the required minimum K2 value associated with a beam to be used for the PUSCH communication (or a beam used for the PDCCH communication), time and/or frequency resources to be used for the PUSCH communication, a multiplexing mode to be used for the PUSCH communication, or an assisting node ID identifying an assisting node (e.g., assisting node 604) to be used to forward or redirect the PUSCH communication to the UE 120.

In some aspects, the PDCCH communication may indicate an offset value for a scheduled aperiodic uplink reference signal (e.g., aperiodic SRS) transmission (e.g., the time offset between the PDCCH communication and the scheduled aperiodic SRS). The offset value for the aperiodic uplink reference signal (e.g., aperiodic SRS) may satisfy the minimum required value for the time offset indicated in the indication transmitted by the UE 120.

As further shown in FIG. 6, and by reference number 635, the UE 120 may transmit, and the network entity 602 may receive, the uplink communication scheduled by the PDCCH communication in accordance with the offset value indicated in the PDCCH communication (e.g., the offset value that satisfies the required minimum value for the time offset indicated by the UE 120). In some aspects, the scheduled uplink communication may be a PUSCH communication. As shown in FIG. 6, the K2 value indicated in the PDCCH communication may indicate the time offset between the PDCCH communication and the uplink communication (e.g., PUSCH communication) scheduled by the PDCCH communication. In some aspects, the uplink communication (e.g., the PUSCH communication) may be transmitted from the UE 120 to the network entity 602 via the assisting node 604. In this case, the K2 value indicated in the PDCCH communication may satisfy a required minimum K2 value (indicated by the UE 120) that is associated with communication between the UE 120 and the network entity 602 via the assisting node 604. In some aspects, the uplink communication (e.g., the PUSCH communication) may be transmitted from the UE 120 to the network entity 602 via a direct link between the UE 120 and the network entity 602. In this case, the K2 value indicated in the PDCCH communication may satisfy a required minimum K2 value (indicated by the UE 120) that is associated with communication via a direct link between the UE 120 and the network entity 602.

In some aspects, the scheduled downlink communication may be an aperiodic uplink reference signal (e.g., an aperiodic SRS) transmission. In some aspects, the uplink reference signal (e.g., the SRS) may be transmitted from the UE 120 to the network entity 602 via the assisting node 604. In this case, the offset value indicated in the PDCCH communication for the uplink reference signal may satisfy a required minimum time offset value (indicated by the UE 120) that is associated with communication between the UE 120 and the network entity 602 via the assisting node 604. In some aspects, the uplink reference signal (e.g., the SRS) may be transmitted from the UE 120 to the network entity 602 via a direct link between the UE 120 and the network entity 602. In this case, the offset value indicated in the PDCCH communication for the uplink reference signal may satisfy a required minimum time offset value (indicated by the UE 120) that is associated with communication via a direct link between the UE 120 and the network entity 602.

As indicated above, FIG. 6 is provided as an example. Other examples may differ from what is described with respect to FIG. 6.

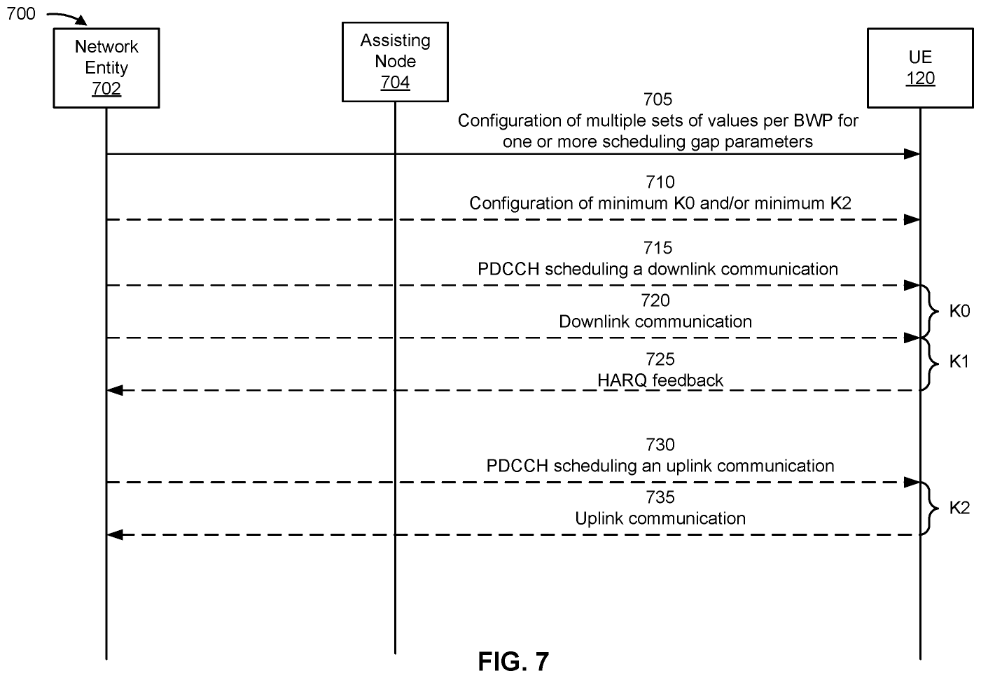

FIG. 7 is a diagram illustrating an example 700 associated with dynamic path switching via an assisting node, in accordance with the present disclosure. As shown in FIG. 7, example 700 includes a network entity 702 (e.g., base station 110, CU 310, DU 330, RU 340, or a combination thereof), a UE 120, and an assisting node 704. In some aspects, the network entity 702, the UE 120, and the assisting node 704 may be included in a wireless network, such as wireless network 100. The network entity 702 and the UE 120 may communicate via a direction link or via the assisting node 704.

In some aspects, the assisting node 704 may be a repeater, a relay, or an RIS. In some aspects, the assisting node 704 may be visible to the network entity 702 (e.g., the network entity 702 may be aware of which path/beam is associated with communications between the network entity 702 and the UE 120 via the assisting node 704), and the network entity 702 may control the assisting node 704 (e.g., via a control interface between network entity 702 and the assisting node 704). In some aspects, the assisting node 704 may be visible to the network entity 702 and the UE 120, and the assisting node 704 may be controlled by the network entity 702, by the UE 120, or jointly by the network entity 702 and the UE 120.

As shown in FIG. 7, and by reference number 705, the network entity 702 may transmit, and the UE 120 may receive, a configuration of multiple sets of values per BWP (for one or more BWPs) for each of one or more scheduling gap parameters. Each scheduling gap parameter may be a time offset associated with a communication between the UE 120 and the network entity 702. In some aspects, the one or more scheduling gap parameters (e.g., time offsets) may include a K0 parameter (e.g., a time offset associated with a downlink communication), a K1 parameter (e.g., a time offset associated with HARQ feedback for a downlink communication), and/or a K2 parameter (e.g., a time offset associated with an uplink communication). For example, the network entity 702 may transmit, and the UE 120 may receive, a configuration of a multiple sets of K0 values (e.g., a plurality of sets of K0 values) for a BWP, a configuration of a multiple sets of K1 values (e.g., a plurality of sets of K1 values) for a BWP, and/or a configuration of a multiple sets of K2 values (e.g., a plurality of sets of K2 values) for a BWP. In some aspects, the network entity 702 may transmit the configuration of the plurality of sets of offset values (e.g., plurality of sets of K0 values, plurality of sets of K1 values, and/or plurality of sets of K2 values) to the UE 120 via a direct link between the UE 120 and the network entity 702. In some aspects, the network entity 702 may transmit the configuration of the plurality of sets of offset values (e.g., plurality of sets of K0 values, plurality of sets of K1 values, and/or plurality of sets of K2 values) to the UE 120 via the assisting node 704. In this case, the assisting node 704 may forward and/or redirect the communication including the configuration of the plurality of sets of offset values to the UE 120. In some aspects, the configuration of multiple sets of offset values for each of one or more scheduling gap parameters (e.g., K0, K1, and/or K2) may be included in one or more RRC messages.

In some aspects, the configuration of the plurality of sets of offset values for a scheduling gap parameter (e.g., K0, K1, or K2) may indicate different sets of configured offset values that are associated with different paths for communications between the network entity 702 and the UE 120. In some aspects, the plurality of sets of offset values may include at least a first set of configured offset values associated with communication between the network entity 702 and the UE 120 without an assisting node (e.g., via a direct link between the UE 120 and the network entity 702) and a second set of configured offset values associated with communication between the network entity 702 and the UE 120 via the assisting node 704. The plurality of sets of offset values may also include one or more sets of configured offset values associated with communications between the network entity 702 and the UE 120 via one or more other assisting nodes. In some aspects, the sets of offset values in the plurality of sets of offset values may be associated with respective beams to be used by the UE 120 for communicating with the network entity. In some aspects, the sets of offset values in the plurality of sets of offset values may be associated with respective time resources (e.g., slot indexes) and/or respective frequency resources (e.g., RBs or RB sets). In some aspects, the sets of offset values in the plurality of sets of offset values may be associated with respective RNTIs, CORESETs, TRPs (e.g., CORESET pools), multiplexing modes (e.g., half-duplex vs. full-duplex and/or single TRP vs. multiple TRP), or MIMO layers. In some aspects, the sets of offset values in the plurality of sets of offset values may be associated with respective assisting node identifiers (e.g., repeater identifiers). In some aspects, the association between the different sets of offset values in the plurality of sets of offset values and one or more parameters described herein may be indicated in an RRC message transmitted from the network entity 702 to the UE 120, or dynamically via a MAC-CE or DCI transmitted from the network entity 702 to the UE 120.

In some aspects, the network entity 702 may transmit, and the UE 120 may receive, a configuration of a plurality of sets of K0 values per BWP (e.g., for one or more BWPs). In some aspects, the plurality of sets of K0 values may include at least a first set of K0 values configured for communication between the network entity 702 and the UE 120 without an assisting node (e.g., via a direct link between the UE 120 and the network entity 702) and a second set of K0 values configured for communication between the network entity 702 and the UE 120 via the assisting node 704. The plurality of sets of K0 values may also include one or more other sets of configured K0 values associated with communications between the network entity 702 and the UE 120 via one or more other assisting nodes.

In some aspects, the sets of K0 values in the plurality of sets of K0 values may be associated with different respective beams (e.g., downlink beams of the UE 120) to be used for downlink communications to the UE 120. For example, each set of K0 values in the plurality of sets of K0 values may be associated with a respective TCI state that identifies a downlink beam of the UE 120 or a respective downlink reference signal ID that identifies a downlink beam of the UE 120. In some aspects, the first set of K0 values may be associated with a first beam for communication between the network entity 702 and the UE 120 via a direct link, and the second set of K0 values may be associated with a second beam for communication between the network entity 702 and the UE 120 via the assisting node 704. When scheduling a downlink communication (e.g., a PDSCH communication) the network entity 702 may select a K0 value from the set of K0 values associated with the beam to be used for the downlink communication. In this way, a K0 value is selected from a set of K0 values configured for a current path being used by the UE 120 (e.g., a path without the assisting node 704 or a path with the assisting node 704).

In some aspects, the sets of K0 values in the plurality of sets of K0 values may be associated with respective time resources (e.g., slot indexes) and/or respective frequency resources (e.g., RBs or RB sets). For example, the first set of K0 values may be associated with a first set of time and/or frequency resources associated with communication between the network entity 702 and the UE 120 via a direct link, and the second set of K0 values may be associated with a second set of time and/or frequency resources associated with communication between the network entity 702 and the UE 120 via the assisting node 704.

In some aspects, the sets of K0 values in the plurality of sets of K0 values may be associated with respective values for one or more other parameters that may be used to distinguish between different paths used for communications between the network entity 702 and the UE 120 (e.g., to distinguish between a first path associated with communications via a direct link, a second path associated with communications via the assisting node 704, and/or one or more other paths associated with communications via one or more other assisting nodes). For example, in some aspects, the sets of K0 values in the plurality of sets of K0 values may be associated with respective RNTIs, respective CORESETs, respective TRPs (e.g., respective CORESET pools), respective multiplexing modes (e.g., half-duplex vs. full-duplex and/or single TRP vs. multiple TRP), or respective MIMO layers. In some aspects, the sets of offset values in the plurality of sets of offset values may be associated with respective assisting node identifiers (e.g., repeater identifiers). In this case, the first set of K0 values may be associated with a first assisting node ID value that is a default assisting node ID value used to indicate communication without an assisting node (e.g., via a direct link between the UE 120 and the network entity 702), and the second set of K0 values may be associated with a second assisting node ID value that identifies the assisting node 704. In some aspects, the association between the different sets of offset values in the plurality of sets of offset values and one or more parameters used to distinguish between different paths for communications between the network entity 702 and the UE 120 herein may be indicated in an RRC message transmitted from the network entity 702 to the UE 120, or may be dynamically indicated in a MAC-CE or DCI transmitted from the network entity 702 to the UE 120.

In some aspects, the network entity 702 may transmit, and the UE 120 may receive, a configuration of a plurality of sets of K1 values per BWP (e.g., for one or more BWPs). In some aspects, the plurality of sets of K1 values may include at least a first set of K1 values configured for communication between the network entity 702 and the UE 120 without an assisting node (e.g., via a direct link between the UE 120 and the network entity 702) and a second set of K1 values configured for communication between the network entity 702 and the UE 120 via the assisting node 704. The plurality of sets of K1 values may also include one or more other sets of configured K1 values associated with communications between the network entity 702 and the UE 120 via one or more other assisting nodes.

In some aspects, the sets of K1 values in the plurality of sets of K1 values may be associated with different respective beams (e.g., downlink beams of the UE 120). For example, each set of K1 values in the plurality of sets of K1 values may be associated with a respective TCI state that identifies a downlink beam of the UE 120 or a respective downlink reference signal ID that identifies a downlink beam of the UE 120. In some aspects, the first set of K1 values may be associated with a first beam for communication between the network entity 702 and the UE 120 via a direct link, and the second set of K1 values may be associated with a second beam for communication between the network entity 702 and the UE 120 via the assisting node 704.

In some aspects, the sets of K1 values in the plurality of sets of K1 values may be associated with respective time resources (e.g., slot indexes) and/or respective frequency resources (e.g., RBs or RB sets). For example, the first set of K1 values may be associated with a first set of time and/or frequency resources associated with communication between the network entity 702 and the UE 120 via a direct link, and the second set of K1 values may be associated with a second set of time and/or frequency resources associated with communication between the network entity 702 and the UE 120 via the assisting node 704.

In some aspects, the sets of K1 values in the plurality of sets of K1 values may be associated with respective values for one or more other parameters that may be used to distinguish between different paths used for communications between the network entity 702 and the UE 120 (e.g., to distinguish between a first path associated with communications via a direct link, a second path associated with communications via the assisting node 704, and/or one or more other paths associated with communications via one or more other assisting nodes). For example, in some aspects, the sets of K1 values in the plurality of sets of K1 values may be associated with respective RNTIs, respective CORESETs, respective TRPs (e.g., respective CORESET pools), respective multiplexing modes (e.g., half-duplex vs. full-duplex and/or single TRP vs. multiple TRP), or respective MIMO layers. In some aspects, the sets of offset values in the plurality of sets of offset values may be associated with respective assisting node identifiers (e.g., repeater identifiers). In this case, the first set of K1 values may be associated with a first assisting node ID value that is a default assisting node ID value used to indicate communication without an assisting node (e.g., via a direct link between the UE 120 and the network entity 702), and the second set of K1 values may be associated with a second assisting node ID value that identifies the assisting node 704. In some aspects, the association between the different sets of offset values in the plurality of sets of offset values and one or more parameters used to distinguish between different paths for communications between the network entity 702 and the UE 120 herein may be indicated in an RRC message transmitted from the network entity 702 to the UE 120, or may be dynamically indicated in a MAC-CE or DCI transmitted from the network entity 702 to the UE 120.

In some aspects, the network entity 702 may transmit, and the UE 120 may receive, a configuration of a plurality of sets of K2 values per BWP (e.g., for one or more BWPs). In some aspects, the plurality of sets of K2 values may include at least a first set of K2 values configured for communication between the network entity 702 and the UE 120 without an assisting node (e.g., via a direct link between the UE 120 and the network entity 702) and a second set of K2 values configured for communication between the network entity 702 and the UE 120 via the assisting node 704. The plurality of sets of K2 values may also include one or more other sets of configured K2 values associated with communications between the network entity 702 and the UE 120 via one or more other assisting nodes.

In some aspects, the sets of K2 values in the plurality of sets of K2 values may be associated with different respective beams (e.g., downlink beams or uplink beams of the UE 120). In some aspects, the first set of K2 values may be associated with a first beam for communication between the network entity 702 and the UE 120 via a direct link, and the second set of K2 values may be associated with a second beam for communication between the network entity 702 and the UE 120 via the assisting node 704. When scheduling an uplink communication (e.g., a PUSCH communication) the network entity 702 may select a K2 value from the set of K2 values associated with the beam to be used for the uplink communication. In this way, a K2 value is selected from a set of K2 values configured for a current path being used by the UE 120 (e.g., a path without the assisting node 704 or a path with the assisting node 704).

In some aspects, the sets of K2 values in the plurality of sets of K2 values may be associated with respective time resources (e.g., slot indexes) and/or respective frequency resources (e.g., RBs or RB sets). For example, the first set of K2 values may be associated with a first set of time and/or frequency resources associated with communication between the network entity 702 and the UE 120 via a direct link, and the second set of K2 values may be associated with a second set of time and/or frequency resources associated with communication between the network entity 702 and the UE 120 via the assisting node 704.

In some aspects, the sets of K2 values in the plurality of sets of K2 values may be associated with respective values for one or more other parameters that may be used to distinguish between different paths used for communications between the network entity 702 and the UE 120 (e.g., to distinguish between a first path associated with communications via a direct link, a second path associated with communications via the assisting node 704, and/or one or more other paths associated with communications via one or more other assisting nodes). For example, in some aspects, the sets of K2 values in the plurality of sets of K2 values may be associated with respective RNTIs, respective CORESETs, respective TRPs (e.g., respective CORESET pools), respective multiplexing modes (e.g., half-duplex vs. full-duplex and/or single TRP vs. multiple TRP), or respective MIMO layers. In some aspects, the sets of offset values in the plurality of sets of offset values may be associated with respective assisting node identifiers (e.g., repeater identifiers). In this case, the first set of K2 values may be associated with a first assisting node ID value that is a default assisting node ID value used to indicate communication without an assisting node (e.g., via a direct link between the UE 120 and the network entity 702), and the second set of K2 values may be associated with a second assisting node ID value that identifies the assisting node 704. In some aspects, the association between the different sets of offset values in the plurality of sets of offset values and one or more parameters used to distinguish between different paths for communications between the network entity 702 and the UE 120 herein may be indicated in an RRC message transmitted from the network entity 702 to the UE 120, or may be dynamically indicated in a MAC-CE or DCI transmitted from the network entity 702 to the UE 120.

In some aspects, the network entity 702 may transmit, and the UE 120 may receive, a configuration of a plurality of sets of offset values for a time offset between a PDCCH communication scheduling (e.g., triggering) an aperiodic downlink reference signal (e.g., an aperiodic CSI-RS) and the scheduled aperiodic downlink reference signal (e.g., the aperiodic CSI-RS). For example, the plurality of sets of offset values may include at least a first set of offset values associated with communication via a direct link between the network entity 702 and the UE 120, and a second set of offset values associated with communication via the assisting node 704.

In some aspects, the network entity 702 may transmit, and the UE 120 may receive, a configuration of a plurality of sets of offset values for a time offset between a PDCCH communication scheduling (e.g., triggering) an aperiodic uplink reference signal (e.g., an aperiodic SRS) and the scheduled aperiodic uplink reference signal (e.g., the aperiodic SRS). For example, the plurality of sets of offset values may include at least a first set of offset values associated with communication via a direct link between the network entity 702 and the UE 120, and a second set of offset values associated with communication via the assisting node 704.

As further shown in FIG. 7, and by reference number 710, in some aspects, the network entity 702 may transmit, and the UE 120 may receive, a configuration of a minimum K0 and/or a minimum K2 for the UE 120. For example, the configuration of the minimum K0 and/or the minimum K2 may be included in an RRC message (or multiple RRC messages). In some aspects, the network entity 702 may transmit the configuration of the minimum K0 and/or the minimum K2 to the UE 120 via a direct link between the network entity 702 and the UE 120. In some aspects, the network entity 702 may transmit the configuration of the minimum K0 and/or the minimum K2 to the UE 120 via the assisting node 704. In this case, the assisting node 704 may forward or redirect the communication (e.g., RRC message) including the configuration of the minimum K0 and/or the minimum K2 value to the UE 120.

In some aspects, the network entity 702 may repurpose the minimum K0 indication to indicate an extended minimum K0 value to be used for communications between the UE 120 and the network entity 702 via the assisting node 704 (and/or other assisting nodes). In some aspects, configuration of the minimum K0 may indicate more than two configured values for the minimum K0 for the UE 120. In some aspects, the configuration of the minimum K0 may indicate multiple sets of configured minimum K0 values per BWP (e.g., for one or more BWPs). In some aspects, respective sets configured minimum K0 values, of the multiple sets of configured minimum K0 values, may be associated with respective beams, respective time and/or frequency resources, respective radio RNTIs, respective CORESETs, respective TRPs (e.g., respective CORESET pools), respective multiplexing modes, respective MIMO layers, and/or respective assisting node IDs. The multiple sets of configured minimum K0 values may include at least a first set of configured minimum K0 values associated with communication between the UE 120 and the network entity 702 without an assisting node (e.g., via a direct link) and a second set of configured minimum K0 values associated with communication between the UE 120 and the network entity 702 via the assisting node 704. The multiple sets of configured minimum K0 values may also include one or more other sets of configured minimum K0 values associated with communication between the UE 120 and the network entity 702 via one or more other assisting nodes.

In some aspects, the network entity 702 may repurpose the minimum K2 indication to indicate an extended minimum K2 value to be used for communications between the UE 120 and the network entity 702 via the assisting node 704 (and/or other assisting nodes). In some aspects, configuration of the minimum K2 may indicate more than two configured values for the minimum K2 for the UE 120. In some aspects, the configuration of the minimum K2 may indicate multiple sets of configured minimum K2 values per BWP (e.g., for one or more BWPs). In some aspects, respective sets configured minimum K2 values, of the multiple sets of configured minimum K2 values, may be associated with respective beams, respective time and/or frequency resources, respective RNTIs, respective CORESETs, respective TRPs (e.g., respective CORESET pools), respective multiplexing modes, respective MIMO layers, and/or respective assisting node IDs. The multiple sets of configured minimum K2 values may include at least a first set of configured minimum K2 values associated with communication between the UE 120 and the network entity 702 without an assisting node (e.g., via a direct link) and a second set of configured minimum K2 values associated with communication between the UE 120 and the network entity 702 via the assisting node 704. The multiple sets of configured minimum K2 values may also include one or more other sets of configured minimum K2 values associated with communication between the UE 120 and the network entity 702 via one or more other assisting nodes.

As further shown in FIG. 7, and by reference number 715, in some aspects, the network entity 702 may transmit, and the UE 120 may receive a PDCCH communication that schedules a downlink communication (e.g., a PDSCH communication or a downlink reference signal). In some aspects, the PDCCH communication may be transmitted from the network entity 702 to the UE 120 via the assisting node 704. In some aspects, the PDCCH communication may be transmitted from the network entity 702 to the UE 120 via a direct link between the UE 120 and the network entity 702. The PDCCH communication may include an indication of an offset value in a set of offset values of the plurality of sets of offset values configured for a time offset associated with the scheduled downlink communication. For example, the indication of the offset value included in the PDCCH communication may map to an offset value in a set of offset values of the plurality of sets of offset value configured for the time offset associated with the scheduled downlink communication. In some aspects, the indication of the offset value included in the PDCCH communication may map to an offset value in a first set of configured offset values associated with communication between the network entity 702 and the UE 120 via a direct link, or the indication of the offset value included in the PDCCH communication may map to a second set of configured offset values associated with communication between the network entity 702 and the UE 120 via the assisting node 704.

In some aspects, the PDCCH communication may include an indication of a K0 value for a scheduled PDSCH communication (e.g., the time offset between the PDCCH communication and the scheduled PDSCH communication). For example, the indication of the K0 value may be included in a bit field of the DCI included in the PDCCH communication, and the indication of the K0 value may map to a configured K0 value in a set of K0 values of the plurality of sets of K0 values configured for the UE 120. In some aspects, the UE 120 may determine the set of K0 values of the plurality of sets of K0 values based at least in part in a beam to be used for the scheduled downlink communication, time and/or frequency resources to be used for the scheduled downlink communication, an RNTI associated with the PDCCH communication, a CORESET in which the PDCCH communication is received, a TRP (e.g., CORESET pool) associated with the PDCCH communication or the scheduled PDSCH communication, a multiplexing mode associated with the scheduled PDSCH communication, a MIMO layer to be used for the scheduled PDSCH communication, or an assisting node identifier associated with the scheduled PDSCH communication. In some aspects, the network entity 702 may transmit, and the UE 120 may receive, a dynamic indication (e.g., via a MAC-CE or DCI) of an activated set of K0 values of the plurality of sets of K0 values. In this case, the indication of the K0 value in the PDCCH communication may map to the activated set of K0 values indicated via the dynamic indication.

In some aspects, the PDCCH communication may include an indication of a K1 value for a scheduled PDSCH communication (e.g., the time offset between the scheduled PDSCH communication and the scheduled transmission of HARQ feedback for the scheduled PDSCH communication). For example, the indication of the K1 value may be included in a bit field of the DCI included in the PDCCH communication, and the indication of the K1 value may map to a configured K1 value in a set of K1 values of the plurality of sets of K1 values configured for the UE 120. In some aspects, the UE 120 may determine the set of K1 values of the plurality of sets of K1 values based at least in part in a beam to be used for the scheduled downlink communication (or the scheduled HARQ feedback), time and/or frequency resources to be used for the scheduled downlink communication (or the scheduled HARQ feedback), an RNTI associated with the PDCCH communication, a CORESET in which the PDCCH communication is received, a TRP (e.g., CORESET pool) associated with the PDCCH communication or the scheduled PDSCH communication (or the scheduled HARQ feedback), a multiplexing mode associated with the scheduled PDSCH communication (or the scheduled HARQ feedback), a MIMO layer to be used for the scheduled PDSCH communication (or the scheduled HARQ feedback), or an assisting node identifier associated with the scheduled PDSCH communication (or the scheduled HARQ feedback). In some aspects, the network entity 702 may transmit, and the UE 120 may receive, a dynamic indication (e.g., via a MAC-CE or DCI) of an activated set of K1 values of the plurality of sets of K1 values. In this case, the indication of the K1 value in the PDCCH communication may map to the activated set of K1 values indicated via the dynamic indication.

In some aspects, the PDCCH communication may include an indication of an offset value for a scheduled aperiodic downlink reference signal (e.g., aperiodic CSI-RS) transmission (e.g., the time offset between the PDCCH communication and the scheduled aperiodic CSI-RS). The indication of the offset value for the aperiodic downlink reference signal (e.g., aperiodic CSI-RS) may map to an offset value in a set of offset values of the plurality of sets of offset values configured for the UE 120. The UE 120 may determine the set of offset values of the plurality of sets of offset values based at least in part on one or more parameters of the PDCCH and/or the scheduled downlink reference signal, or based at least in part on a dynamic indication of an activated set of offset parameters transmitted from the network entity 702 to the UE 120.

As further shown in FIG. 7, and by reference number 720, the network entity 702 may transmit, and the UE 120 may receive, the downlink communication scheduled by the PDCCH communication in accordance with the offset value indicated in the PDCCH communication (e.g., the offset value in the set of offset values of the plurality of sets of offset values configured for the UE 120). In some aspects, the scheduled downlink communication may be a PDSCH communication. As shown in FIG. 7, the K0 value indicated in the PDCCH communication may indicate the time offset between the PDCCH communication and the downlink communication (e.g., PDSCH communication) scheduled by the PDCCH communication. In some aspects, the downlink communication (e.g., the PDSCH communication) may be transmitted from the network entity 702 to the UE 120 via the assisting node 704. In this case, the K0 value indicated in the PDCCH communication may be K0 value in a set of K0 values configured for communication between the network entity 702 and the UE 120 via the assisting node 704 (e.g., the second set of K0 values). In some aspects, the downlink communication (e.g., the PDSCH communication) may be transmitted from the network entity 702 to the UE 120 via a direct link between the network entity 702 and the UE 120. In this case, the K0 value indicated in the PDCCH communication may be a K0 value in a set of K0 values configured for communication between the network entity 702 and the UE 120 via a direct link (e.g., the first set of K0 values).

In some aspects, the scheduled downlink communication may be an aperiodic downlink reference signal (e.g., an aperiodic CSI-RS) transmission. In some aspects, the downlink reference signal (e.g., the CSI-RS) may be transmitted from the network entity 702 to the UE 120 via the assisting node 704. In this case, the offset value indicated in the PDCCH communication for the downlink reference signal may be an offset value in a set of offset values configured for communication between the network entity 702 and the UE 120 via the assisting node 704. In some aspects, the downlink reference signal (e.g., the CSI-RS) may be transmitted from the network entity 702 to the UE 120 via a direct link between the network entity 702 and the UE 120. In this case, the offset value indicated in the PDCCH communication for the downlink reference signal may be an offset value in a set of offset values configured for communication between the network entity 702 and the UE 120 via a direct link.

As further shown in FIG. 7, and by reference number 725, the UE 120 may transmit, and the network entity 702 may receive, HARQ feedback for the downlink communication (e.g., the PDSCH communication) received by the UE 120. For example, the HARQ feedback may include a HARQ-ACK indication or a HARQ-NACK indication. As shown in FIG. 7, the K1 value indicated in the PDCCH communication may indicate the time offset between the downlink communication (e.g., the PDSCH communication) and the scheduled transmission of the HARQ feedback for the PDSCH communication. In some aspects, the HARQ feedback may be transmitted from the UE 120 to the network entity 702 via the assisting node 704. In this case, the K1 value indicated in the PDCCH communication may be K1 value in a set of K1 values configured for communication between the network entity 702 and the UE 120 via the assisting node 704 (e.g., the second set of K1 values). In some aspects, the HARQ feedback may be transmitted from the UE 120 to the network entity 702 via a direct link between the UE 120 and the network entity 702. In this case, the K1 value indicated in the PDCCH communication may be a K1 value in a set of K1 values configured for communication between the network entity 702 and the UE 120 via a direct link (e.g., the first set of K1 values).

As further shown in FIG. 7, and by reference number 730, in some aspects, the network entity 702 may transmit, and the UE 120 may receive, a PDCCH communication that schedules an uplink communication (e.g., a PUSCH communication or an uplink reference signal) to be transmitted by the UE 120. In some aspects, the PDCCH communication may be transmitted from the network entity 702 to the UE 120 via the assisting node 704. In some aspects, the PDCCH communication may be transmitted from the network entity 702 to the UE 120 via a direct link between the UE 120 and the network entity 702. The PDCCH communication may include an indication of an offset value in a set of offset values of the plurality of sets of offset values configured for a time offset associated with the scheduled uplink communication. For example, the indication of the offset value included in the PDCCH communication may map to an offset value in a set of offset values of the plurality of sets of offset value configured for the time offset associated with the scheduled uplink communication. In some aspects, the indication of the offset value included in the PDCCH communication may map to an offset value in a first set of configured offset values associated with communication between the network entity 702 and the UE 120 via a direct link, or the indication of the offset value included in the PDCCH communication may map to a second set of configured offset values associated with communication between the network entity 702 and the UE 120 via the assisting node 704.

In some aspects, the PDCCH communication may include an indication of a K2 value for a scheduled PUSCH communication (e.g., the time offset between the PDCCH communication and the scheduled PUSCH communication). For example, the indication of the K2 value may be included in a bit field of the DCI included in the PDCCH communication, and the indication of the K2 value may map to a configured K2 value in a set of K2 values of the plurality of sets of K2 values configured for the UE 120. In some aspects, the UE 120 may determine the set of K2 values of the plurality of sets of K2 values based at least in part in a beam to be used for the scheduled uplink communication (or the beam used for the PDCCH communication), time and/or frequency resources to be used for the scheduled uplink communication, an RNTI associated with the PDCCH communication, a CORESET in which the PDCCH communication is received, a TRP (e.g., CORESET pool) associated with the PDCCH communication or the scheduled PUSCH communication, a multiplexing mode associated with the scheduled PUSCH communication, a MIMO layer to be used for the scheduled PUSCH communication, or an assisting node identifier associated with the scheduled PUSCH communication. In some aspects, the network entity 702 may transmit, and the UE 120 may receive, a dynamic indication (e.g., via a MAC-CE or DCI) of an activated set of K2 values of the plurality of sets of K2 values. In this case, the indication of the K2 value in the PDCCH communication may map to the activated set of K2 values indicated via the dynamic indication.

In some aspects, the PDCCH communication may include an indication of an offset value for a scheduled aperiodic uplink reference signal (e.g., aperiodic SRS) transmission (e.g., the time offset between the PDCCH communication and the scheduled aperiodic SRS). The indication of the offset value for the aperiodic uplink reference signal (e.g., aperiodic SRS) may map to an offset value in a set of offset values of the plurality of sets of offset values configured for the UE 120. The UE 120 may determine the set of offset values of the plurality of sets of offset values based at least in part on one or more parameters of the PDCCH and/or the scheduled uplink reference signal, or based at least in part on a dynamic indication of an activated set of offset parameters transmitted from the network entity 702 to the UE 120.

As further shown in FIG. 7, and by reference number 735, the UE 120 may transmit, and the network entity 702 may receive, the uplink communication scheduled by the PDCCH communication in accordance with the offset value indicated in the PDCCH communication (e.g., the offset value in the set of offset values of the plurality of sets of offset values configured for the UE 120). In some aspects, the scheduled downlink communication may be a PUSCH communication. As shown in FIG. 7, the K2 value indicated in the PDCCH communication may indicate the time offset between the PDCCH communication and the uplink communication (e.g., PUSCH communication) scheduled by the PDCCH communication. In some aspects, the uplink communication (e.g., the PUSCH communication) may be transmitted from the UE 120 to the network entity 702 via the assisting node 704. In this case, the K2 value indicated in the PDCCH communication may be K2 value in a set of K2 values configured for communication between the UE 120 and the network entity 702 via the assisting node 704 (e.g., the second set of K2 values). In some aspects, the uplink communication (e.g., the PUSCH communication) may be transmitted from the UE 120 to the network entity 702 via a direct link between the UE 120 and the network entity 702. In this case, the K2 value indicated in the PDCCH communication may be a K2 value in a set of K2 values configured for communication between UE 120 and the network entity 702 via a direct link (e.g., the first set of K2 values).

In some aspects, the scheduled uplink communication may be an aperiodic uplink reference signal (e.g., an aperiodic SRS) transmission. In some aspects, the uplink reference signal (e.g., the SRS) may be transmitted from the UE 120 to the network entity 702 via the assisting node 704. In this case, the offset value indicated in the PDCCH communication for the uplink reference signal may be an offset value in a set of offset values configured for communication between the UE 120 and the network entity 702 via the assisting node 704. In some aspects, the uplink reference signal (e.g., the SRS) may be transmitted from the UE 120 to the network entity 702 via a direct link between the UE 120 and the network entity 702. In this case, the offset value indicated in the PDCCH communication for the uplink reference signal may be an offset value in a set of offset values configured for communication between the UE 120 and the network entity 702.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with dynamic path switch via an assisting node.

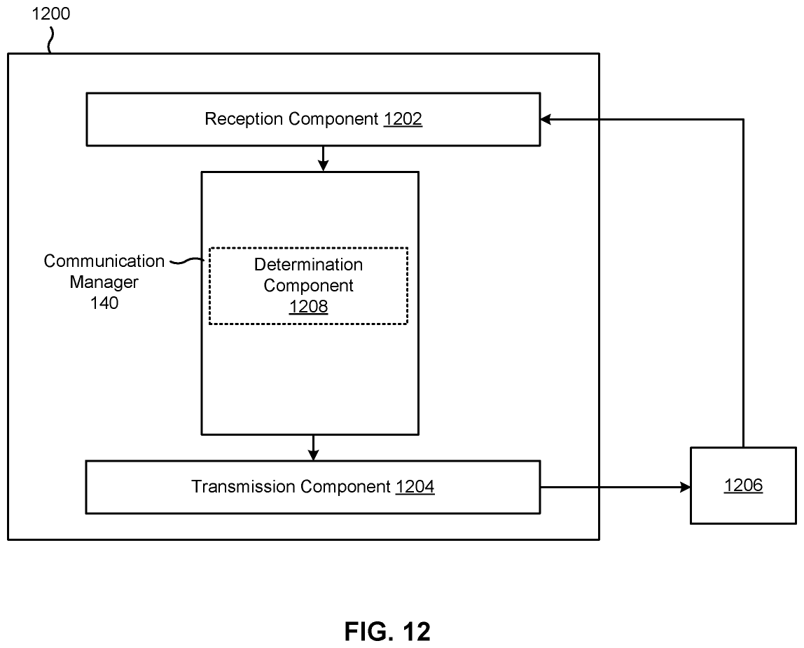

As shown in FIG. 8, in some aspects, process 800 may include transmitting, to a network entity, an indication of a required minimum value for a time offset associated with a communication with the network entity, wherein the required minimum value for the time offset is associated with communicating with the network entity via an assisting node (block 810). For example, the UE (e.g., using communication manager 140 and/or transmission component 1204, depicted in FIG. 12) may transmit, to a network entity, an indication of a required minimum value for a time offset associated with a communication with the network entity, wherein the required minimum value for the time offset is associated with communicating with the network entity via an assisting node, as described above.

As further shown in FIG. 8, in some aspects, process 800 may include receiving, from the network entity, an indication of an offset value for the time offset based at least in part on the required minimum value for the time offset (block 820). For example, the UE (e.g., using communication manager 140 and/or reception component 1202, depicted in FIG. 12) may receive, from the network entity, an indication of an offset value for the time offset based at least in part on the required minimum value for the time offset, as described above.

As further shown in FIG. 8, in some aspects, process 800 may include communicating with the network entity via the assisting node in accordance with the offset value (block 830). For example, the UE (e.g., using communication manager 140, reception component 1202, and/or transmission component 1204, depicted in FIG. 12) may communicate with the network entity via the assisting node in accordance with the offset value, as described above.

Process 800 may include additional aspects, such as any single aspect or any combination of aspects described below and/or in connection with one or more other processes described elsewhere herein.

In a first aspect, the required minimum value for the time offset is a beam-specific required minimum value associated with a beam used by the UE for communicating with the network entity via the assisting node.

In a second aspect, transmitting the indication of the required minimum value for the time offset includes transmitting the indication of the required minimum value for the time offset in connection with switching between a first communication path between the UE and the network entity and a second communication path between the UE and the network entity, and the second communication path between the UE and the network entity is associated with communicating with the network entity via the assisting node.

In a third aspect, the indication of the required minimum value for the time offset is included in UCI or a MAC-CE.

In a fourth aspect, the required minimum value for the time offset is associated with at least one of time or frequency resources associated with communicating with the network entity via the assisting node.

In a fifth aspect, the required minimum value for the time offset is associated with a multiplexing mode associated with communicating with the network entity via the assisting node.

In a sixth aspect, the required minimum value for the time offset is associated with an identifier associated with the assisting node.

In a seventh aspect, transmitting the indication of the required minimum value for the time offset includes transmitting, to the network entity, at least one of a required minimum K0 value for a PDSCH communication to be transmitted to the UE via the assisting node, a required minimum K1 value for a HARQ feedback communication to be transmitted to the network entity via the assisting node, or a required minimum K2 value for a PUSCH communication to be transmitted to the network entity via the assisting node.

In an eighth aspect, the required minimum value for the time offset is a required minimum K0 value.

In a ninth aspect, receiving the indication of the offset value for the time offset includes receiving a PDCCH communication including an indication of a K0 value, based at least in part on the required minimum K0 value, for a scheduled PDSCH, and communicating with the network entity via the assisting node in accordance with the offset value includes receiving the scheduled PDSCH communication, via the assisting node, in accordance with the K0 value.

In a tenth aspect, the required minimum value for the time offset is a required minimum K1 value.

In an eleventh aspect, receiving the indication of the offset value for the time offset includes receiving a PDCCH communication including an indication of a K1 value, based at least in part on the required minimum K1 value, for HARQ feedback for a scheduled PDSCH, and communicating with the network entity via the assisting node in accordance with the offset value includes transmitting the HARQ feedback for the scheduled PDSCH communication to the network entity, via the assisting node, in accordance with the K1 value.

In a twelfth aspect, the required minimum value for the time offset is a required minimum K2 value.

In a thirteenth aspect, receiving the indication of the offset value for the time offset includes receiving a PDCCH communication including an indication of a K2 value, based at least in part on the required minimum K2 value, for a scheduled PUSCH, and communicating with the network entity via the assisting node in accordance with the offset value includes transmitting the scheduled PUSCH communication to the network entity, via the assisting node, in accordance with the K2 value.

In a fourteenth aspect, transmitting the indication of the required minimum value for the time offset includes transmitting, to the network entity, an indication of an adjusted time duration for QCL associated with communicating with the network entity via the assisting node.

In a fifteenth aspect, the adjusted time duration for QCL is associated with a beam pair including a PDCCH beam and a PDSCH beam, and the PDCCH beam or the PDSCH beam is associated with communicating with the network entity via the assisting node.

In a sixteenth aspect, the time offset is an offset between a PDCCH communication and an aperiodic downlink reference signal scheduled by the PDCCH communication.

In a seventeenth aspect, the time offset is an offset between a PDCCH communication and an aperiodic uplink reference signal scheduled by the PDCCH communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network entity 602) performs operations associated with dynamic path switch via an assisting node.

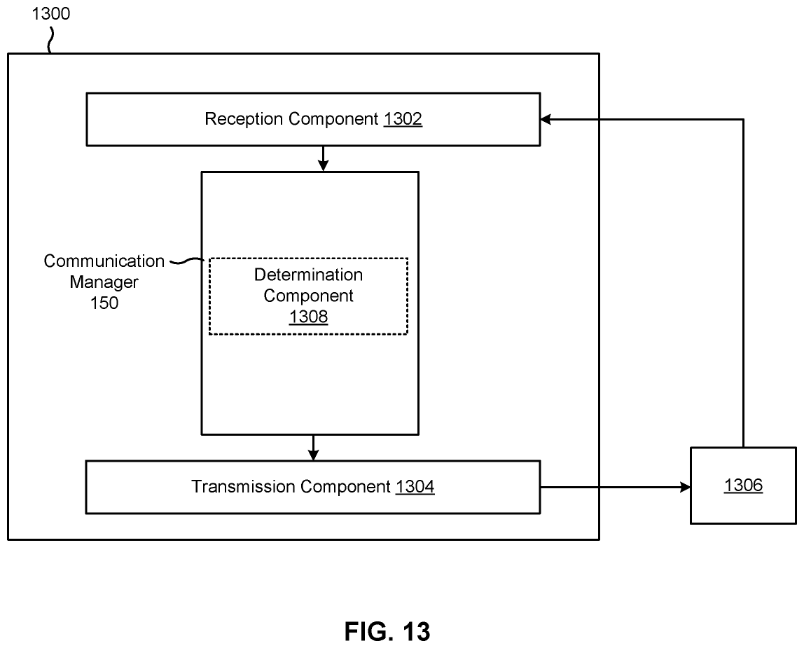

As shown in FIG. 9, in some aspects, process 900 may include receiving an indication of a required minimum value for a time offset associated with a communication with a UE, wherein the required minimum value for the time offset is associated with communicating with the UE via an assisting node (block 910). For example, the network entity (e.g., using communication manager 150 and/or reception component 1302, depicted in FIG. 13) may receive an indication of a required minimum value for a time offset associated with a communication with a UE, wherein the required minimum value for the time offset is associated with communicating with the UE via an assisting node, as described above.

As further shown in FIG. 9, in some aspects, process 900 may include transmitting, to the UE, an indication of an offset value for the time offset based at least in part on the required minimum value for the time offset (block 920). For example, the network entity (e.g., using communication manager 150 and/or transmission component 1304, depicted in FIG. 13) may transmit, to the UE, an indication of an offset value for the time offset based at least in part on the required minimum value for the time offset, as described above.

As further shown in FIG. 9, in some aspects, process 900 may include communicating with the UE in accordance with the offset value (block 930). For example, the network entity (e.g., using communication manager 150, reception component 1302, and/or transmission component 1304, depicted in FIG. 13) may communicate with the UE in accordance with the offset value, as described above.

Process 900 may include additional aspects, such as any single aspect or any combination of aspects described below and/or in connection with one or more other processes described elsewhere herein.

In a first aspect, the required minimum value for the time offset is a beam-specific required minimum value associated with a beam used by the UE for communicating with the network entity via the assisting node.

In a second aspect, receiving the indication of the required minimum value for the time offset includes receiving the indication of the required minimum value for the time offset in connection switching between a first communication path between the UE and the network entity and a second communication path between the UE and the network entity, and the second communication path between the UE and the network entity is associated with communicating with the network entity via the assisting node.

In a third aspect, the indication of the required minimum value for the time offset is included in UCI or a MAC-CE.

In a fourth aspect, the required minimum value for the time offset is associated with at least one of time or frequency resources associated with communicating with the network entity via the assisting node.

In a fifth aspect, the required minimum value for the time offset is associated with a multiplexing mode associated with communicating with the network entity via the assisting node.

In a sixth aspect, the required minimum value for the time offset is associated with an identifier associated with the assisting node.

In a seventh aspect, receiving the indication of the required minimum value for the time offset includes receiving, from the UE, at least one of a required minimum K0 value for a PDSCH communication to be transmitted to the UE via the assisting node, a required minimum K1 value for a HARQ feedback communication to be transmitted to the network entity via the assisting node, or a required minimum K2 value for a PUSCH communication to be transmitted to the network entity via the assisting node.

In an eighth aspect, the required minimum value for the time offset is a required minimum K0 value.

In a ninth aspect, transmitting the indication of the offset value for the time offset includes transmitting a PDCCH communication including an indication of a K0 value, based at least in part on the required minimum K0 value, for a scheduled PDSCH, and communicating with the UE via the assisting node in accordance with the offset value includes transmitting the scheduled PDSCH communication to the UE, via the assisting node, in accordance with the K0 value.

In a tenth aspect, the required minimum value for the time offset is a required minimum K1 value.

In an eleventh aspect, transmitting the indication of the offset value for the time offset includes transmitting a PDCCH communication including an indication of a K1 value, based at least in part on the required minimum K1 value, for HARQ feedback for a scheduled PDSCH, and communicating with the UE via the assisting node in accordance with the offset value includes receiving the HARQ feedback for the scheduled PDSCH communication from the UE, via the assisting node, in accordance with the K1 value.

In a twelfth aspect, the required minimum value for the time offset is a required minimum K2 value.

In a thirteenth aspect, transmitting the indication of the offset value for the time offset includes transmitting a PDCCH communication including an indication of a K2 value, based at least in part on the required minimum K2 value, for a scheduled PUSCH, and communicating with the UE via the assisting node in accordance with the offset value includes receiving the scheduled PUSCH communication from the UE, via the assisting node, in accordance with the K2 value.

In a fourteenth aspect, receiving the indication of the required minimum value for the time offset includes receiving, from the UE, an indication of an adjusted time duration for QCL associated with communicating with the network entity via the assisting node.

In a fifteenth aspect, the adjusted time duration for QCL is associated with a beam pair including a PDCCH beam and a PDSCH beam, and the PDCCH beam or the PDSCH beam is associated with communicating with the network entity via the assisting node.

In a sixteenth aspect, the time offset is an offset between a PDCCH communication and an aperiodic downlink reference signal scheduled by the PDCCH communication.

In a seventeenth aspect, the time offset is an offset between a PDCCH communication and an aperiodic uplink reference signal scheduled by the PDCCH communication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with dynamic path switch via an assisting node.

As shown in FIG. 10, in some aspects, process 1000 may include receiving, from a network entity, a configuration of a plurality of sets of offset values for a bandwidth part, for a time offset associated with a communication with the network entity (block 1010). For example, the UE (e.g., using communication manager 140 and/or reception component 1202, depicted in FIG. 12) may receive, from a network entity, a configuration of a plurality of sets of offset values for a bandwidth part, for a time offset associated with a communication with the network entity, as described above.

As further shown in FIG. 10, in some aspects, process 1000 may include receiving, from the network entity, an indication of an offset value, in a set of offset values of the plurality of sets of offset values, for the time offset (block 1020). For example, the UE (e.g., using communication manager 140 and/or reception component 1202, depicted in FIG. 12) may receive, from the network entity, an indication of an offset value, in a set of offset values of the plurality of sets of offset values, for the time offset, as described above.

As further shown in FIG. 10, in some aspects, process 1000 may include communicating with the network entity in accordance with the offset value (block 1030). For example, the UE (e.g., using communication manager 140, reception component 1202, and/or transmission component 1204, depicted in FIG. 12) may communicate with the network entity in accordance with the offset value, as described above.

Process 1000 may include additional aspects, such as any single aspect or any combination of aspects described below and/or in connection with one or more other processes described elsewhere herein.

In a first aspect, the sets of offset values in the plurality of sets of offset values are associated with respective beams to be used by the UE for communicating with the network entity.

In a second aspect, the sets of offset values in the plurality of sets of offset values are associated with at least one of respective time resources or respective frequency resources.

In a third aspect, the sets of offset values in the plurality of sets of offset values are associated with respective RNTIs, CORESETs, TRPs, multiplexing modes, or MIMO layers.

In a fourth aspect, the sets of offset values in the plurality of sets of offset values are associated with respective assisting node identifiers.

In a fifth aspect, process 1000 includes receiving, from the network entity, an indication of an activated set of offset values of the plurality of sets of offset values, and the indication of the offset value indicates the offset value in the activated set of offset values.

In a sixth aspect, the indication of the activated set of offset values is included in a MAC-CE or DCI.

In a seventh aspect, the plurality of sets of offset values includes a first set of offset values associated with communication between the UE and the network entity without an assisting node and a second set of offset values associated with communication between the UE and the network entity via an assisting node.

In an eighth aspect, the plurality of sets of offset values includes a plurality of sets of K0 values.

In a ninth aspect, receiving the indication of the offset value includes receiving a PDCCH communication including an indication of a K0 value, in a set of K0 values of the plurality of sets of K0 values, for a scheduled PDSCH, and communicating with the network entity in accordance with the offset value includes receiving the scheduled PDSCH communication in accordance with the K0 value.

In a tenth aspect, the plurality of sets of offset values includes a plurality of sets of K1 values.

In an eleventh aspect, receiving the indication of the offset value includes receiving a PDCCH communication including an indication of a K1 value, in a set of K1 values of the plurality of sets of K1 values, for HARQ feedback for a scheduled PDSCH, and communicating with the network entity in accordance with the offset value includes transmitting the HARQ feedback for the scheduled PDSCH communication to the network entity in accordance with the K1 value.

In a twelfth aspect, the plurality of sets of offset values includes a plurality of sets of K2 values.

In a thirteenth aspect, receiving the indication of the offset value includes receiving a PDCCH communication including an indication of a K2 value, in a set of K2 values of the plurality of sets of K2 values, for a scheduled PUSCH, and communicating with the network entity in accordance with the offset value includes transmitting the scheduled PUSCH communication to the network entity in accordance with the K2 value.

In a fourteenth aspect, the time offset is an offset between a PDCCH communication and an aperiodic downlink reference signal scheduled by the PDCCH communication.

In a fifteenth aspect, the time offset is an offset between a PDCCH communication and an aperiodic uplink reference signal scheduled by the PDCCH communication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network entity 702) performs operations associated with dynamic path switch via an assisting node.

As shown in FIG. 11, in some aspects, process 1100 may include transmitting, to a UE, a configuration of a plurality of sets of offset values for a bandwidth part, for a time offset associated with a communication with the UE (block 1110). For example, the network entity (e.g., using communication manager 150 and/or transmission component 1304, depicted in FIG. 13) may transmit, to a UE, a configuration of a plurality of sets of offset values for a bandwidth part, for a time offset associated with a communication with the UE, as described above.

As further shown in FIG. 11, in some aspects, process 1100 may include transmitting, to the UE, an indication of an offset value, in a set of offset values of the plurality of sets of offset values, for the time offset (block 1120). For example, the network entity (e.g., using communication manager 150 and/or transmission component 1304, depicted in FIG. 13) may transmit, to the UE, an indication of an offset value, in a set of offset values of the plurality of sets of offset values, for the time offset, as described above.

As further shown in FIG. 11, in some aspects, process 1100 may include communicating with the UE in accordance with the offset value (block 1130). For example, the network entity (e.g., using communication manager 150, reception component 1302, and/or transmission component 1304, depicted in FIG. 13) may communicate with the UE in accordance with the offset value, as described above.

Process 1100 may include additional aspects, such as any single aspect or any combination of aspects described below and/or in connection with one or more other processes described elsewhere herein.

In a first aspect, the sets of offset values in the plurality of sets of offset values are associated with respective beams to be used by the UE for communicating with the network entity.

In a second aspect, the sets of offset values in the plurality of sets of offset values are associated with at least one of respective time resources or respective frequency resources.

In a third aspect, the sets of offset values in the plurality of sets of offset values are associated with respective RNTIs, CORESETs, TRPs, multiplexing modes, or MIMO layers.

In a fourth aspect, the sets of offset values in the plurality of sets of offset values are associated with respective assisting node identifiers.

In a fifth aspect, process 1100 includes transmitting, to the UE, an indication of an activated set of offset values of the plurality of sets of offset values, and the indication of the offset value indicates the offset value in the activated set of offset values.

In a sixth aspect, the indication of the activated set of offset values is included in a MAC-CE or DCI.

In a seventh aspect, the plurality of sets of offset values includes a first set of offset values associated with communication between the UE and the network entity without an assisting node and a second set of offset values associated with communication between the UE and the network entity via an assisting node.

In an eighth aspect, the plurality of sets of offset values includes a plurality of sets of K0 values.

In a ninth aspect, transmitting the indication of the offset value includes transmitting a PDCCH communication including an indication of a K0 value, in a set of K0 values of the plurality of sets of K0 values, for a scheduled PDSCH, and communicating with the UE in accordance with the offset value includes transmitting the scheduled PDSCH communication in accordance with the K0 value.

In a tenth aspect, the plurality of sets of offset values includes a plurality of sets of K1 values.

In an eleventh aspect, transmitting the indication of the offset value includes transmitting a PDCCH communication including an indication of a K1 value, in a set of K1 values of the plurality of sets of K1 values, for HARQ feedback for a scheduled PDSCH, and communicating with the UE in accordance with the offset value includes receiving the HARQ feedback for the scheduled PDSCH communication from the UE in accordance with the K1 value.

In a twelfth aspect, the plurality of sets of offset values includes a plurality of sets of K2 values.

In a thirteenth aspect, transmitting the indication of the offset value includes transmitting a PDCCH communication including an indication of a K2 value, in a set of K2 values of the plurality of sets of K2 values, for a scheduled PUSCH, and communicating with the UE in accordance with the offset value includes receiving the scheduled PUSCH communication from the UE in accordance with the K2 value.

In a fourteenth aspect, the time offset is an offset between a PDCCH communication and an aperiodic downlink reference signal scheduled by the PDCCH communication.

In a fifteenth aspect, the time offset is an offset between a PDCCH communication and an aperiodic uplink reference signal scheduled by the PDCCH communication.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a determination component 1208, among other examples.

In some aspects, the apparatus 1200 may be configured to perform one or more operations described herein in connection with FIGS. 6-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The transmission component 1204 may transmit, to a network entity, an indication of a required minimum value for a time offset associated with a communication with the network entity, wherein the required minimum value for the time offset is associated with communicating with the network entity via an assisting node. The reception component 1202 may receive, from the network entity, an indication of an offset value for the time offset based at least in part on the required minimum value for the time offset. The reception component 1202 and/or the transmission component 1204 may communicate with the network entity via the assisting node in accordance with the offset value.

The determination component 1208 may determine the required minimum value for the time offset.

The reception component 1202 may receive, from a network entity, a configuration of a plurality of sets of offset values for a bandwidth part, for a time offset associated with a communication with the network entity. The reception component 1202 may receive, from the network entity, an indication of an offset value, in a set of offset values of the plurality of sets of offset values, for the time offset. The reception component 1202 and/or the transmission component 1204 may communicate with the network entity in accordance with the offset value.

The reception component 1202 may receive, from the network entity, an indication of an activated set of offset values of the plurality of sets of offset values, wherein the indication of the offset value indicates the offset value in the activated set of offset values.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a determination component 1308, among other examples.

In some aspects, the apparatus 1300 may be configured to perform one or more operations described herein in connection with FIGS. 6-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

The reception component 1302 may receive an indication of a required minimum value for a time offset associated with a communication with a UE, wherein the required minimum value for the time offset is associated with communicating with the UE via an assisting node. The transmission component 1304 may transmit, to the UE, an indication of an offset value for the time offset based at least in part on the required minimum value for the time offset. The reception component 1302 and/or the transmission component 1304 may communicate with the UE in accordance with the offset value.

The determination component 1308 may determine the offset value for the time offset based at least in part on the required minimum value for the time offset.

The transmission component 1304 may transmit, to a UE, a configuration of a plurality of sets of offset values for a bandwidth part, for a time offset associated with a communication with the UE. The transmission component 1304 may transmit, to the UE, an indication of an offset value, in a set of offset values of the plurality of sets of offset values, for the time offset. The reception component 1302 and/or the transmission component 1304 may communicate with the UE in accordance with the offset value.

The transmission component 1304 may transmit, to the UE, an indication of an activated set of offset values of the plurality of sets of offset values, wherein the indication of the offset value indicates the offset value in the activated set of offset values.

The determination component 1308 may determine the plurality of sets of offset values for the bandwidth part, for the time offset.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting, to a network entity, an indication of a required minimum value for a time offset associated with a communication with the network entity, wherein the required minimum value for the time offset is associated with communicating with the network entity via an assisting node; receiving, from the network entity, an indication of an offset value for the time offset based at least in part on the required minimum value for the time offset; and communicating with the network entity via the assisting node in accordance with the offset value.

Aspect 2: The method of Aspect 1, wherein the required minimum value for the time offset is a beam-specific required minimum value associated with a beam used by the UE for communicating with the network entity via the assisting node.

Aspect 3: The method of any of Aspects 1-2, wherein transmitting the indication of the required minimum value for the time offset comprises: transmitting the indication of the required minimum value for the time offset in connection with switching between a first communication path between the UE and the network entity and a second communication path between the UE and the network entity, wherein the second communication path between the UE and the network entity is associated with communicating with the network entity via the assisting node.

Aspect 4: The method of any of Aspects 1-3, wherein the indication of the required minimum value for the time offset is included in uplink control information (UCI) or a medium access control (MAC) control element (MAC-CE).

Aspect 5: The method of any of Aspects 1-4, wherein the required minimum value for the time offset is associated with at least one of time or frequency resources associated with communicating with the network entity via the assisting node.

Aspect 6: The method of any of Aspects 1-5, wherein the required minimum value for the time offset is associated with a multiplexing mode associated with communicating with the network entity via the assisting node.

Aspect 7: The method of any of Aspects 1-6, wherein the required minimum value for the time offset is associated with an identifier associated with the assisting node.

Aspect 8: The method of any of Aspects 1-7, wherein transmitting the indication of the required minimum value for the time offset comprises: transmitting, to the network entity, at least one of a required minimum K0 value for a physical downlink shared channel (PDSCH) communication to be transmitted to the UE via the assisting node, a required minimum K1 value for a hybrid automatic repeat request (HARD) feedback communication to be transmitted to the network entity via the assisting node, or a required minimum K2 value for a physical uplink shared channel (PUSCH) communication to be transmitted to the network entity via the assisting node.

Aspect 9: The method of any of Aspects 1-8, wherein the required minimum value for the time offset is a required minimum K0 value.

Aspect 10: The method of Aspect 9, wherein receiving the indication of the offset value for the time offset comprises receiving a physical downlink control channel (PDCCH) communication including an indication of a K0 value, based at least in part on the required minimum K0 value, for a scheduled physical downlink shared channel communication (PDSCH), and wherein communicating with the network entity via the assisting node in accordance with the offset value comprises: receiving the scheduled PDSCH communication, via the assisting node, in accordance with the K0 value.

Aspect 11: The method of any of Aspects 1-10, wherein the required minimum value for the time offset is a required minimum K1 value.

Aspect 12: The method of Aspect 11, wherein receiving the indication of the offset value for the time offset comprises receiving a physical downlink control channel (PDCCH) communication including an indication of a K1 value, based at least in part on the required minimum K1 value, for hybrid automatic repeat request (HARQ) feedback for a scheduled physical downlink shared channel communication (PDSCH), and wherein communicating with the network entity via the assisting node in accordance with the offset value comprises: transmitting the HARQ feedback for the scheduled PDSCH communication to the network entity, via the assisting node, in accordance with the K1 value.

Aspect 13: The method of any of Aspects 1-12, wherein the required minimum value for the time offset is a required minimum K2 value.

Aspect 14: The method of Aspect 13, wherein receiving the indication of the offset value for the time offset comprises receiving a physical downlink control channel (PDCCH) communication including an indication of a K2 value, based at least in part on the required minimum K2 value, for a scheduled physical uplink shared channel communication (PUSCH), and wherein communicating with the network entity via the assisting node in accordance with the offset value comprises: transmitting the scheduled PUSCH communication to the network entity, via the assisting node, in accordance with the K2 value.

Aspect 15: The method of any of Aspects 1-14, wherein transmitting the indication of the required minimum value for the time offset comprises: transmitting, to the network entity, an indication of an adjusted time duration for quasi co-location (QCL) associated with communicating with the network entity via the assisting node.

Aspect 16: The method of Aspect 15, wherein the adjusted time duration for QCL is associated with a beam pair including a physical downlink control channel (PDCCH) beam and a physical downlink shared channel (PDSCH) beam, and wherein the PDCCH beam or the PDSCH beam is associated with communicating with the network entity via the assisting node.

Aspect 17: The method of any of Aspects 1-16, wherein the time offset is an offset between a physical downlink control channel (PDCCH) communication and an aperiodic downlink reference signal scheduled by the PDCCH communication.

Aspect 18: The method of any of Aspects 1-17, wherein the time offset is an offset between a physical downlink control channel (PDCCH) communication and an aperiodic uplink reference signal scheduled by the PDCCH communication.

Aspect 19: A method of wireless communication performed by a network entity, comprising: receiving an indication of a required minimum value for a time offset associated with a communication with a user equipment (UE), wherein the required minimum value for the time offset is associated with communicating with the UE via an assisting node; transmitting, to the UE, an indication of an offset value for the time offset based at least in part on the required minimum value for the time offset; and communicating with the UE in accordance with the offset value.

Aspect 20: The method of Aspect 19, wherein the required minimum value for the time offset is a beam-specific required minimum value associated with a beam used by the UE for communicating with the network entity via the assisting node.

Aspect 21: The method of any of Aspects 19-20, wherein receiving the indication of the required minimum value for the time offset comprises: receiving the indication of the required minimum value for the time offset in connection switching between a first communication path between the UE and the network entity and a second communication path between the UE and the network entity, wherein the second communication path between the UE and the network entity is associated with communicating with the network entity via the assisting node.

Aspect 22: The method of any of Aspects 19-21, wherein the indication of the required minimum value for the time offset is included in uplink control information (UCI) or a medium access control (MAC) control element (MAC-CE).

Aspect 23: The method of any of Aspects 19-22, wherein the required minimum value for the time offset is associated with at least one of time or frequency resources associated with communicating with the network entity via the assisting node.

Aspect 24: The method of any of Aspects 19-23, wherein the required minimum value for the time offset is associated with a multiplexing mode associated with communicating with the network entity via the assisting node.

Aspect 25: The method of any of Aspects 19-24, wherein the required minimum value for the time offset is associated with an identifier associated with the assisting node.

Aspect 26: The method of any of Aspects 19-25, wherein receiving the indication of the required minimum value for the time offset comprises: receiving, from the UE, at least one of a required minimum K0 value for a physical downlink shared channel (PDSCH) communication to be transmitted to the UE via the assisting node, a required minimum K1 value for a hybrid automatic repeat request (HARQ) feedback communication to be transmitted to the network entity via the assisting node, or a required minimum K2 value for a physical uplink shared channel (PUSCH) communication to be transmitted to the network entity via the assisting node.

Aspect 27: The method of any of Aspects 19-26, wherein the required minimum value for the time offset is a required minimum K0 value.

Aspect 28: The method of Aspect 27, wherein transmitting the indication of the offset value for the time offset comprises transmitting a physical downlink control channel (PDCCH) communication including an indication of a K0 value, based at least in part on the required minimum K0 value, for a scheduled physical downlink shared channel communication (PDSCH), and wherein communicating with the UE via the assisting node in accordance with the offset value comprises: transmitting the scheduled PDSCH communication to the UE, via the assisting node, in accordance with the K0 value.

Aspect 29: The method of any of Aspects 19-28, wherein the required minimum value for the time offset is a required minimum K1 value.

Aspect 30: The method of Aspect 29, wherein transmitting the indication of the offset value for the time offset comprises transmitting a physical downlink control channel (PDCCH) communication including an indication of a K1 value, based at least in part on the required minimum K1 value, for hybrid automatic repeat request (HARQ) feedback for a scheduled physical downlink shared channel communication (PDSCH), and wherein communicating with the UE via the assisting node in accordance with the offset value comprises: receiving the HARQ feedback for the scheduled PDSCH communication from the UE, via the assisting node, in accordance with the K1 value.

Aspect 31: The method of any of Aspects 19-30, wherein the required minimum value for the time offset is a required minimum K2 value.

Aspect 32: The method of Aspect 31, wherein transmitting the indication of the offset value for the time offset comprises transmitting a physical downlink control channel (PDCCH) communication including an indication of a K2 value, based at least in part on the required minimum K2 value, for a scheduled physical uplink shared channel communication (PUSCH), and wherein communicating with the UE via the assisting node in accordance with the offset value comprises: receiving the scheduled PUSCH communication from the UE, via the assisting node, in accordance with the K2 value.

Aspect 33: The method of any of Aspects 19-32, wherein receiving the indication of the required minimum value for the time offset comprises: receiving, from the UE, an indication of an adjusted time duration for quasi co-location (QCL) associated with communicating with the network entity via the assisting node.

Aspect 34: The method of Aspect 33, wherein the adjusted time duration for QCL is associated with a beam pair including a physical downlink control channel (PDCCH) beam and a physical downlink shared channel (PDSCH) beam, and wherein the PDCCH beam or the PDSCH beam is associated with communicating with the network entity via the assisting node.

Aspect 35: The method of any of Aspects 19-34, wherein the time offset is an offset between a physical downlink control channel (PDCCH) communication and an aperiodic downlink reference signal scheduled by the PDCCH communication.

Aspect 36: The method of any of Aspects 19-35, wherein the time offset is an offset between a physical downlink control channel (PDCCH) communication and an aperiodic uplink reference signal scheduled by the PDCCH communication.

Aspect 37: A method of wireless communication performed by a user equipment (UE), comprising: receiving, from a network entity, a configuration of a plurality of sets of offset values for a bandwidth part, for a time offset associated with a communication with the network entity; receiving, from the network entity, an indication of an offset value, in a set of offset values of the plurality of sets of offset values, for the time offset; and communicating with the network entity in accordance with the offset value.

Aspect 38: The method of Aspect 37, wherein the sets of offset values in the plurality of sets of offset values are associated with respective beams to be used by the UE for communicating with the network entity.

Aspect 39: The method of any of Aspects 37-38, wherein the sets of offset values in the plurality of sets of offset values are associated with at least one of respective time resources or respective frequency resources.

Aspect 40: The method of any of Aspects 37-39, wherein the sets of offset values in the plurality of sets of offset values are associated with respective radio network temporary identifiers (RNTIs), control resource sets (CORESETs), transmit receive points (TRPs), multiplexing modes, or multiple-input multiple-output (MIMO) layers.

Aspect 41: The method of any of Aspects 37-40, wherein the sets of offset values in the plurality of sets of offset values are associated with respective assisting node identifiers.

Aspect 42: The method of any of Aspects 37-41, further comprising: receiving, from the network entity, an indication of an activated set of offset values of the plurality of sets of offset values, wherein the indication of the offset value indicates the offset value in the activated set of offset values.

Aspect 43: The method of Aspect 42, wherein the indication of the activated set of offset values is included in a medium access control (MAC) control element (MAC-CE) or downlink control information (DCI).

Aspect 44: The method of any of Aspects 37-43, wherein the plurality of sets of offset values comprises a first set of offset values associated with communication between the UE and the network entity without an assisting node and a second set of offset values associated with communication between the UE and the network entity via an assisting node.

Aspect 45: The method of any of Aspects 37-44, wherein the plurality of sets of offset values comprises a plurality of sets of K0 values.

Aspect 46: The method of Aspect 45, wherein receiving the indication of the offset value comprises receiving a physical downlink control channel (PDCCH) communication including an indication of a K0 value, in a set of K0 values of the plurality of sets of K0 values, for a scheduled physical downlink shared channel communication (PDSCH), and wherein communicating with the network entity in accordance with the offset value comprises: receiving the scheduled PDSCH communication in accordance with the K0 value.

Aspect 47: The method of any of Aspects 37-46, wherein the plurality of sets of offset values comprises a plurality of sets of K1 values.

Aspect 48: The method of Aspect 47, wherein receiving the indication of the offset value comprises receiving a physical downlink control channel (PDCCH) communication including an indication of a K1 value, in a set of K1 values of the plurality of sets of K1 values, for hybrid automatic repeat request (HARQ) feedback for a scheduled physical downlink shared channel communication (PDSCH), and wherein communicating with the network entity in accordance with the offset value comprises: transmitting the HARQ feedback for the scheduled PDSCH communication to the network entity in accordance with the K1 value.

Aspect 49: The method of any of Aspects 37-48, wherein the plurality of sets of offset values comprises a plurality of sets of K2 values.

Aspect 50: The method of Aspect 49, wherein receiving the indication of the offset value comprises receiving a physical downlink control channel (PDCCH) communication including an indication of a K2 value, in a set of K2 values of the plurality of sets of K2 values, for a scheduled physical uplink shared channel communication (PUSCH), and wherein communicating with the network entity in accordance with the offset value comprises: transmitting the scheduled PUSCH communication to the network entity in accordance with the K2 value.

Aspect 51: The method of any of Aspects 37-50, wherein the time offset is an offset between a physical downlink control channel (PDCCH) communication and an aperiodic downlink reference signal scheduled by the PDCCH communication.

Aspect 52: The method of any of Aspects 37-51, wherein the time offset is an offset between a physical downlink control channel (PDCCH) communication and an aperiodic uplink reference signal scheduled by the PDCCH communication.

Aspect 53: A method of wireless communication performed by a network entity, comprising: transmitting, to a user equipment (UE), a configuration of a plurality of sets of offset values for a bandwidth part, for a time offset associated with a communication with the UE; transmitting, to the UE, an indication of an offset value, in a set of offset values of the plurality of sets of offset values, for the time offset; and communicating with the UE in accordance with the offset value.

Aspect 54: The method of Aspect 53, wherein the sets of offset values in the plurality of sets of offset values are associated with respective beams to be used by the UE for communicating with the network entity.

Aspect 55: The method of any of Aspects 53-54, wherein the sets of offset values in the plurality of sets of offset values are associated with at least one of respective time resources or respective frequency resources.

Aspect 56: The method of any of Aspects 53-55, wherein the sets of offset values in the plurality of sets of offset values are associated with respective radio network temporary identifiers (RNTIs), control resource sets (CORESETs), transmit receive points (TRPs), multiplexing modes, or multiple-input multiple-output (MIMO) layers.

Aspect 57: The method of any of Aspects 53-56, wherein the sets of offset values in the plurality of sets of offset values are associated with respective assisting node identifiers.

Aspect 58: The method of any of Aspects 53-57, further comprising: transmitting, to the UE, an indication of an activated set of offset values of the plurality of sets of offset values, wherein the indication of the offset value indicates the offset value in the activated set of offset values.

Aspect 59: The method of Aspect 58, wherein the indication of the activated set of offset values is included in a medium access control (MAC) control element (MAC-CE) or downlink control information (DCI).

Aspect 60: The method of any of Aspects 53-59, wherein the plurality of sets of offset values comprises a first set of offset values associated with communication between the UE and the network entity without an assisting node and a second set of offset values associated with communication between the UE and the network entity via an assisting node.

Aspect 61: The method of any of Aspects 53-60, wherein the plurality of sets of offset values comprises a plurality of sets of K0 values.

Aspect 62: The method of Aspect 61, wherein transmitting the indication of the offset value comprises transmitting a physical downlink control channel (PDCCH) communication including an indication of a K0 value, in a set of K0 values of the plurality of sets of K0 values, for a scheduled physical downlink shared channel communication (PDSCH), and wherein communicating with the UE in accordance with the offset value comprises: transmitting the scheduled PDSCH communication in accordance with the K0 value.

Aspect 63: The method of any of Aspects 53-62, wherein the plurality of sets of offset values comprises a plurality of sets of K1 values.

Aspect 64: The method of Aspect 63, wherein transmitting the indication of the offset value comprises transmitting a physical downlink control channel (PDCCH) communication including an indication of a K1 value, in a set of K1 values of the plurality of sets of K1 values, for hybrid automatic repeat request (HARQ) feedback for a scheduled physical downlink shared channel communication (PDSCH), and wherein communicating with the UE in accordance with the offset value comprises: receiving the HARQ feedback for the scheduled PDSCH communication from the UE in accordance with the K1 value.

Aspect 65: The method of any of Aspects 53-64, wherein the plurality of sets of offset values comprises a plurality of sets of K2 values.

Aspect 66: The method of Aspect 65, wherein transmitting the indication of the offset value comprises transmitting a physical downlink control channel (PDCCH) communication including an indication of a K2 value, in a set of K2 values of the plurality of sets of K2 values, for a scheduled physical uplink shared channel communication (PUSCH), and wherein communicating with the UE in accordance with the offset value comprises: receiving the scheduled PUSCH communication from the UE in accordance with the K2 value.

Aspect 67: The method of any of Aspects 53-66, wherein the time offset is an offset between a physical downlink control channel (PDCCH) communication and an aperiodic downlink reference signal scheduled by the PDCCH communication.

Aspect 68: The method of any of Aspects 53-67, wherein the time offset is an offset between a physical downlink control channel (PDCCH) communication and an aperiodic uplink reference signal scheduled by the PDCCH communication.

Aspect 69: An apparatus for wireless communication at a device, comprising a processor; memory coupled with the processor; and instructions stored in the memory and executable by the processor to cause the apparatus to perform the method of one or more of Aspects 1-18.

Aspect 70: A device for wireless communication, comprising a memory and one or more processors coupled to the memory, the one or more processors configured to perform the method of one or more of Aspects 1-18.

Aspect 71: An apparatus for wireless communication, comprising at least one means for performing the method of one or more of Aspects 1-18.

Aspect 72: A non-transitory computer-readable medium storing code for wireless communication, the code comprising instructions executable by a processor to perform the method of one or more of Aspects 1-18.

Aspect 73: A non-transitory computer-readable medium storing a set of instructions for wireless communication, the set of instructions comprising one or more instructions that, when executed by one or more processors of a device, cause the device to perform the method of one or more of Aspects 1-18.

Aspect 74: An apparatus for wireless communication at a device, comprising a processor; memory coupled with the processor; and instructions stored in the memory and executable by the processor to cause the apparatus to perform the method of one or more of Aspects 19-36.

Aspect 75: A device for wireless communication, comprising a memory and one or more processors coupled to the memory, the one or more processors configured to perform the method of one or more of Aspects 19-36.

Aspect 76: An apparatus for wireless communication, comprising at least one means for performing the method of one or more of Aspects 19-36.

Aspect 77: A non-transitory computer-readable medium storing code for wireless communication, the code comprising instructions executable by a processor to perform the method of one or more of Aspects 19-36.

Aspect 78: A non-transitory computer-readable medium storing a set of instructions for wireless communication, the set of instructions comprising one or more instructions that, when executed by one or more processors of a device, cause the device to perform the method of one or more of Aspects 19-36.

Aspect 79: An apparatus for wireless communication at a device, comprising a processor; memory coupled with the processor; and instructions stored in the memory and executable by the processor to cause the apparatus to perform the method of one or more of Aspects 37-52.

Aspect 80: A device for wireless communication, comprising a memory and one or more processors coupled to the memory, the one or more processors configured to perform the method of one or more of Aspects 37-52.

Aspect 81: An apparatus for wireless communication, comprising at least one means for performing the method of one or more of Aspects 37-52.

Aspect 82: A non-transitory computer-readable medium storing code for wireless communication, the code comprising instructions executable by a processor to perform the method of one or more of Aspects 37-52.

Aspect 83: A non-transitory computer-readable medium storing a set of instructions for wireless communication, the set of instructions comprising one or more instructions that, when executed by one or more processors of a device, cause the device to perform the method of one or more of Aspects 37-52.

Aspect 84: An apparatus for wireless communication at a device, comprising a processor; memory coupled with the processor; and instructions stored in the memory and executable by the processor to cause the apparatus to perform the method of one or more of Aspects 53-68.

Aspect 85: A device for wireless communication, comprising a memory and one or more processors coupled to the memory, the one or more processors configured to perform the method of one or more of Aspects 53-68.

Aspect 86: An apparatus for wireless communication, comprising at least one means for performing the method of one or more of Aspects 53-68.

Aspect 87: A non-transitory computer-readable medium storing code for wireless communication, the code comprising instructions executable by a processor to perform the method of one or more of Aspects 53-68.

Aspect 88: A non-transitory computer-readable medium storing a set of instructions for wireless communication, the set of instructions comprising one or more instructions that, when executed by one or more processors of a device, cause the device to perform the method of one or more of Aspects 53-68.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a network entity, an indication of a required minimum value for a time offset associated with a communication with the network entity, wherein the required minimum value for the time offset is associated with communicating with the network entity via an assisting node;
receive, from the network entity, an indication of an offset value for the time offset based at least in part on the required minimum value for the time offset; and
communicate with the network entity via the assisting node in accordance with the offset value.

2. The UE of claim 1, wherein the required minimum value for the time offset is a beam-specific required minimum value associated with a beam used by the UE for communicating with the network entity via the assisting node.

3. The UE of claim 1, wherein the one or more processors, to transmit the indication of the required minimum value for the time offset, are configured to:
transmit the indication of the required minimum value for the time offset in connection with switching between a first communication path between the UE and the network entity and a second communication path between the UE and the network entity, wherein the second communication path between the UE and the network entity is associated with communicating with the network entity via the assisting node.

4. The UE of claim 1, wherein the required minimum value for the time offset is associated with at least one of time or frequency resources associated with communicating with the network entity via the assisting node.

5. The UE of claim 1, wherein the required minimum value for the time offset is associated with a multiplexing mode associated with communicating with the network entity via the assisting node.

6. The UE of claim 1, wherein the required minimum value for the time offset is associated with an identifier associated with the assisting node.

7. The UE of claim 1, wherein the one or more processors, to transmit the indication of the required minimum value for the time offset, are configured to:
transmit, to the network entity, at least one of a required minimum K0 value for a physical downlink shared channel (PDSCH) communication to be transmitted to the UE via the assisting node, a required minimum K1 value for a hybrid automatic repeat request (HARQ) feedback communication to be transmitted to the network entity via the assisting node, or a required minimum K2 value for a physical uplink shared channel (PUSCH) communication to be transmitted to the network entity via the assisting node.

8. The UE of claim 1, wherein the required minimum value for the time offset is a required minimum K0 value.

9. The UE of claim 8, wherein receiving the indication of the offset value for the time offset comprises receiving a physical downlink control channel (PDCCH) communication including an indication of a K0 value, based at least in part on the required minimum K0 value, for a scheduled physical downlink shared channel communication (PDSCH), and wherein the one or more processors, to communicate with the network entity via the assisting node in accordance with the offset value, are configured to:
receive the scheduled PDSCH communication, via the assisting node, in accordance with the K0 value.

10. The UE of claim 1, wherein the required minimum value for the time offset is a required minimum K1 value, wherein receiving the indication of the offset value for the time offset comprises receiving a physical downlink control channel (PDCCH) communication including an indication of a K1 value, based at least in part on the required minimum K1 value, for hybrid automatic repeat request (HARQ) feedback for a scheduled physical downlink shared channel communication (PDSCH), and wherein the one or more processors, to communicate with the network entity via the assisting node in accordance with the offset value, are configured to:
transmit the HARQ feedback for the scheduled PDSCH communication to the network entity, via the assisting node, in accordance with the K1 value.

11. The UE of claim 1, wherein the required minimum value for the time offset is a required minimum K2 value, wherein receiving the indication of the offset value for the time offset comprises receiving a physical downlink control channel (PDCCH) communication including an indication of a K2 value, based at least in part on the required minimum K2 value, for a scheduled physical uplink shared channel communication (PUSCH), and wherein the one or more processors, to communicate with the network entity via the assisting node in accordance with the offset value, are configured to:
transmit the scheduled PUSCH communication to the network entity, via the assisting node, in accordance with the K2 value.

12. The UE of claim 1, wherein the one or more processors, to transmit the indication of the required minimum value for the time offset, are configured to:
transmit, to the network entity, an indication of an adjusted time duration for quasi co-location (QCL) associated with communicating with the network entity via the assisting node.

13. The UE of claim 12, wherein the adjusted time duration for QCL is associated with a beam pair including a physical downlink control channel (PDCCH) beam and a physical downlink shared channel (PDSCH) beam, and wherein the PDCCH beam or the PDSCH beam is associated with communicating with the network entity via the assisting node.

14. A user equipment (UE) for wireless communication, comprising:
a memory; and
one or more processors, coupled to the memory, configured to:
receive, from a network entity, a configuration of a plurality of sets of offset values for a bandwidth part, for a time offset associated with a communication with the network entity;
receive, from the network entity, an indication of an offset value, in a set of offset values of the plurality of sets of offset values, for the time offset; and
communicate with the network entity in accordance with the offset value.

15. The UE of claim 14, wherein the sets of offset values in the plurality of sets of offset values are associated with respective beams to be used by the UE for communicating with the network entity.

16. The UE of claim 14, wherein the sets of offset values in the plurality of sets of offset values are associated with at least one of respective time resources or respective frequency resources.

17. The UE of claim 14, wherein the sets of offset values in the plurality of sets of offset values are associated with respective radio network temporary identifiers (RNTIs), control resource sets (CORESETs), transmit receive points (TRPs), multiplexing modes, or multiple-input multiple-output (MIMO) layers.

18. The UE of claim 14, wherein the sets of offset values in the plurality of sets of offset values are associated with respective assisting node identifiers.

19. The UE of claim 14, wherein the one or more processors are further configured to:
receive, from the network entity, an indication of an activated set of offset values of the plurality of sets of offset values, wherein the indication of the offset value indicates the offset value in the activated set of offset values.

20. The UE of claim 14, wherein the plurality of sets of offset values comprises a first set of offset values associated with communication between the UE and the network entity without an assisting node and a second set of offset values associated with communication between the UE and the network entity via an assisting node.

21. The UE of claim 14, wherein the plurality of sets of offset values comprises a plurality of sets of K0 values, wherein the one or more processors, to receive the indication of the offset value, are configured to receive a physical downlink control channel (PDCCH) communication including an indication of a K0 value, in a set of K0 values of the plurality of sets of K0 values, for a scheduled physical downlink shared channel communication (PDSCH), and wherein to one or more processors, to communicate with the network entity in accordance with the offset value, are configured to:
receive the scheduled PDSCH communication in accordance with the K0 value.

22. The UE of claim 14, wherein the plurality of sets of offset values comprises a plurality of sets of K1 values, wherein the one or more processors, to receive the indication of the offset value, are configured to receive a physical downlink control channel (PDCCH) communication including an indication of a K1 value, in a set of K1 values of the plurality of sets of K1 values, for hybrid automatic repeat request (HARQ) feedback for a scheduled physical downlink shared channel communication (PDSCH), and wherein, the one or more processors, to communicate with the network entity in accordance with the offset value, are configured to:
transmit the HARQ feedback for the scheduled PDSCH communication to the network entity in accordance with the K1 value.

23. The UE of claim 14, wherein the plurality of sets of offset values comprises a plurality of sets of K2 values, wherein the one or more processors, to receive the indication of the offset value, are configure to receive a physical downlink control channel (PDCCH) communication including an indication of a K2 value, in a set of K2 values of the plurality of sets of K2 values, for a scheduled physical uplink shared channel communication (PUSCH), and wherein, the one or more processors to communicate with the network entity in accordance with the offset value, are configured to:
transmit the scheduled PUSCH communication to the network entity in accordance with the K2 value.

24. A method of wireless communication performed by a user equipment (UE), comprising:
transmitting, to a network entity, an indication of a required minimum value for a time offset associated with a communication with the network entity, wherein the required minimum value for the time offset is associated with communicating with the network entity via an assisting node;
receiving, from the network entity, an indication of an offset value for the time offset based at least in part on the required minimum value for the time offset; and
communicating with the network entity via the assisting node in accordance with the offset value.

25. The method of claim 24, wherein the required minimum value for the time offset is a beam-specific required minimum value associated with a beam used by the UE for communicating with the network entity via the assisting node.

26. The method of claim 24, wherein transmitting the indication of the required minimum value for the time offset comprises:
transmitting the indication of the required minimum value for the time offset in connection with switching between a first communication path between the UE and the network entity and a second communication path between the UE and the network entity, wherein the second communication path between the UE and the network entity is associated with communicating with the network entity via the assisting node.

27. The method of claim 24, wherein the required minimum value for the time offset is a required minimum K0 value, wherein receiving the indication of the offset value for the time offset comprises receiving a physical downlink control channel (PDCCH) communication including an indication of a K0 value, based at least in part on the required minimum K0 value, for a scheduled physical downlink shared channel communication (PDSCH), and wherein communicating with the network entity via the assisting node in accordance with the offset value comprises:
receiving the scheduled PDSCH communication, via the assisting node, in accordance with the K0 value.

28. A method of wireless communication performed by a user equipment (UE), comprising:
receiving, from a network entity, a configuration of a plurality of sets of offset values for a bandwidth part, for a time offset associated with a communication with the network entity;
receiving, from the network entity, an indication of an offset value, in a set of offset values of the plurality of sets of offset values, for the time offset; and
communicating with the network entity in accordance with the offset value.

29. The method of claim 28, wherein the plurality of sets of offset values comprises a first set of offset values associated with communication between the UE and the network entity without an assisting node and a second set of offset values associated with communication between the UE and the network entity via an assisting node.

30. The method of claim 28, wherein the plurality of sets of offset values comprises a plurality of sets of K0 values, wherein receiving the indication of the offset value comprises receiving a physical downlink control channel (PDCCH) communication including an indication of a K0 value, in a set of K0 values of the plurality of sets of K0 values, for a scheduled physical downlink shared channel communication (PDSCH), and wherein communicating with the network entity in accordance with the offset value comprises:
receiving the scheduled PDSCH communication in accordance with the K0 value.
